(19) United States
(12) Patent Application Publication
(10) Pub. No.: US 2023/0198712 A1
(43) Pub. Date: Jun. 22, 2023

(54) METHOD AND APPARATUS FOR REPORTING ON TIME-VARYING CSI IN WIRELESS COMMUNICATION SYSTEMS

(71) Applicant: Samsung Electronics Co., Ltd., Suwon-si (KR)

(72) Inventors: Ameha Tsegaye ABEBE, Suwon-si (KR); Junyung YI, Suwon-si (KR); Seongmok LIM, Suwon-si (KR); Yeongeun LIM, Suwon-si (KR); Youngrok JANG, Suwon-si (KR); Hyoungju JI, Suwon-si (KR)

(21) Appl. No.: 18/084,985

(22) Filed: Dec. 20, 2022

(30) Foreign Application Priority Data
Dec. 20, 2021 (KR) 10-2021-0182881

(51) Int. Cl. H04L 5/00; H04W 24/10

(52) U.S. Cl. CPC H04L 5/0051; H04W 24/10

(57) ABSTRACT

The disclosure relates to a 5th generation (5G) communication system or a 6th generation (6G) communication system for supporting higher data rates beyond a 4th generation (4G) communication system such as long term evolution (LTE). In accordance with an aspect of the disclosure, a method performed by a user equipment (UE) in a communication system is provided. The method includes transmitting, to a base station, capability information indicating a capability for time correlated channel state information (CSI) report, receiving, from the base station, configuration for the time correlated CSI report, obtaining N CSI reports based on one or more CSI-reference signals (CSI-RS), the N CSI reports being applied to N time intervals, transmitting the N CSI reports to the base station.

### CROSS-REFERENCE TO RELATED APPLICATION(S)

This application is based on and claims priority under 35 U.S.C. § 119(a) of a Korean patent application number 10-2021-0182881, filed on Dec. 20, 2021, in the Korean Intellectual Property Office, the disclosure of which is incorporated by reference herein in its entirety.

### BACKGROUND

### 1. Field

The disclosure relates to the field of 5th generation (5G) communication networks. More particularly, the disclosure relates to a channel state information (CSI) reporting for time-correlated channel in multiple-input multiple-output (MIMO) system.

### 2. Description of Related Art

To meet the demand for wireless data traffic having increased since deployment of 4th generation (4G) communication systems, efforts have been made to develop an improved 5G or pre-5G communication system. Therefore, the 5G or pre-5G communication system is also called a ‘Beyond 4G Network’ or a ‘Post long-term evolution (LTE) System’. The 5G communication system is considered to be implemented in higher frequency (mmWave) bands, e.g., 60 gigahertz (GHz) bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication are implemented by beamforming, MIMO, and array antennas. Application of a cloud Radio Access Network (RAN) as the above-described Big Data processing technology may also be considered to be as an example of convergence between the 5G technology and the IoT technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and apparatus for time-correlated channel state information (CSI) reporting in communication network, wherein the communication network is at least one of the Fifth Generation (5G) standalone network and a 5G non-standalone (NAS) network.

Another aspect of the disclosure is to provide methods and systems to configure a user equipment (UE) with channel state information reference signal (CSI-RS) resources that may be used to measure time-correlated CSI.

Another aspect of the disclosure is to configure a UE with CSI reporting configuration, that may be used to report time-correlated CSI.

Another aspect of the disclosure is to configure a UE with CSI reporting configuration that may be used to report time-correlated CSI in an efficient manner by utilizing various codebook types.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes transmitting, to a base station, capability information indicating a capability for time correlated channel state information (CSI) report, receiving, from the base station, configuration for the time correlated CSI report, obtaining N CSI reports based on one or more CSI-reference signals (CSI-RS), the N CSI reports being applied to N time intervals, transmitting the N CSI reports to the base station.

In accordance with another aspect of the disclosure, a method performed by a base station in a communication system is provided. The method includes receiving, from a user equipment (UE), capability information indicating a capability for time correlated channel state information (CSI) report, transmitting, to the UE, configuration for the time correlated CSI report, receiving, from the UE, N CSI reports based on one or more CSI-reference signals (CSI-RS), the N CSI reports being applied to N time intervals.

In accordance with another aspect of the disclosure, a user equipment (UE) in a communication system is provided. The UE includes a transceiver, and a controller configured to transmit, to a base station, capability information indicating a capability for time correlated channel state information (CSI) report, receive, from the base station, configuration for the time correlated CSI report, obtain N CSI reports based on one or more CSI-reference signals (CSI-RS), the N CSI reports being applied to N time intervals, transmit the N CSI reports to the base station.

In accordance with another aspect of the disclosure, a base station in a communication system is provided. The base station includes a transceiver, and a controller configured to receive, from a user equipment (UE), capability information indicating a capability for time correlated channel state information (CSI) report, transmit, to the UE, configuration for the time correlated CSI report, receive, from the UE, N CSI reports based on one or more CSI-reference signals (CSI-RS), the N CSI reports being applied to N time intervals.

The disclosure provides method and apparatus for reporting on time-varying CSI in wireless communication systems.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the disclosure;

FIG. 2A illustrates example wireless transmit paths according to an embodiment of the disclosure;

FIG. 2B illustrates example wireless receive paths according to an embodiment of the disclosure;

FIG. 3A illustrate an example UE according to an embodiment of the disclosure;

FIG. 3B illustrates an example gNB according to an embodiment of the disclosure;

FIG. 4 illustrates a cross-polarized MIMO antenna system according to an embodiment of the disclosure;

FIG. 5 illustrates a layout for channel state information reference signal (CSI-RS) resource mapping in an orthogonal frequency division multiple access (OFDM) time-frequency grid according to an embodiment of the disclosure;

FIG. 6 illustrates an example of precoder construction in Type II CSI according to an embodiment of the disclosure;

FIG. 7A illustrates a reporting of precoding matrices in subband granularity according to an embodiment of the disclosure;

FIG. 7B illustrates a precoding matrix construction for enhanced Type II CSI according to an embodiment of the disclosure;

FIG. 8 illustrates channel aging in high and medium mobility scenario according to an embodiment of the disclosure;

FIG. 9 depicts an embodiment for disclosure wherein a UE reports multiple CSI that may be applied to multiple application time according to an embodiment of the disclosure;

FIG. 10 illustrates a channel estimation and prediction block at a UE according to an embodiment of the disclosure;

FIG. 11 illustrates a process for channel prediction according to an embodiment of the disclosure;

FIG. 12 illustrates a message exchange and signaling for UE capability reporting and RRC configuration to enable time-correlated CSI reporting according to an embodiment of the disclosure;

FIG. 13 illustrates a configuration of CSI-RS resources that may be used to derive time-correlated CSI according to an embodiment of the disclosure;

FIG. 14 illustrates a time-correlated CSI reporting for Type I CSI according to an embodiment of the disclosure;

FIG. 15 illustrates a time-correlated CSI reporting for Type I CSI with Doppler co-phasing correction coefficients according to an embodiment of the disclosure;

FIG. 16 illustrates a time-correlated CSI reporting for Type II CSI with Doppler co-phasing correction coefficients according to an embodiment of the disclosure;

FIG. 17 illustrates a time-correlated CSI reporting with subset of spatial basis according to an embodiment of the disclosure;

FIG. 18 illustrates a time-correlated CSI reporting for enhanced Type II CSI with Doppler co-phasing correction coefficients according to an embodiment of the disclosure;

FIG. 19 illustrates FD-basis specific and FD-basis common reporting of Doppler co-phasing correction coefficients for enhanced Type II CSI according to an embodiment of the disclosure; and

FIG. 20 illustrates FD-basis specific and FD-basis common reporting of Doppler co-phasing correction coefficients for further enhanced Type II CSI according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

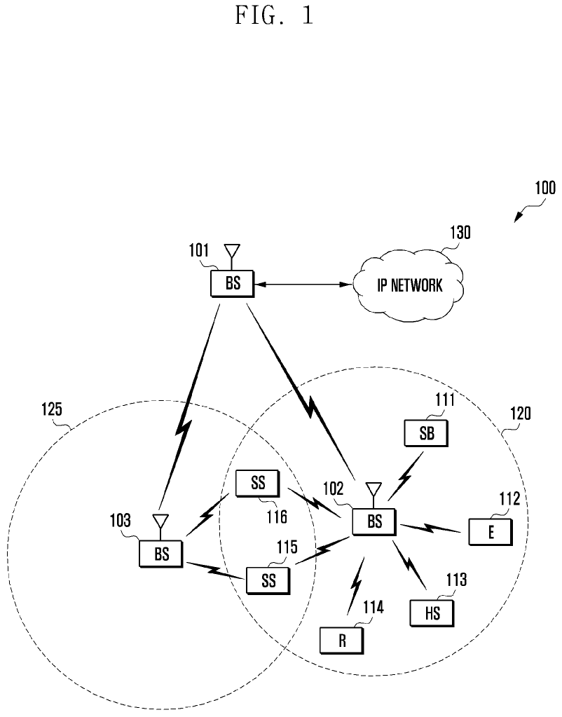

FIG. 1 illustrates an example wireless network according to an embodiment of the disclosure. The embodiment of a wireless network 100 shown in FIG. 1 is for illustration only. Other embodiments of the wireless network 100 may be used without departing from the scope of this disclosure.

Referring to FIG. 1, the wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ may refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance, and the like.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, and the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the disclosure. In some embodiments, one or more of BS 101, BS (i.e., gNB 102) and BS (i.e., gNB 103) support the codebook design and structure for systems having 2D antenna arrays.

Although FIG. 1 illustrates one example of a wireless network 100, various changes may be made to FIG. 1. For example, the wireless network 100 may include any number of gNBs and any number of UEs in any suitable arrangement. Also, the gNB 101 may communicate directly with any number of UEs and provide those UEs with wireless broadband access to the network 130. Similarly, each gNB 102-103 may communicate directly with the network 130 and provide UEs with direct wireless broadband access to the network 130. Further, the gNB 101, 102, and/or 103 may provide access to other or additional external networks, such as external telephone networks or other types of data networks.

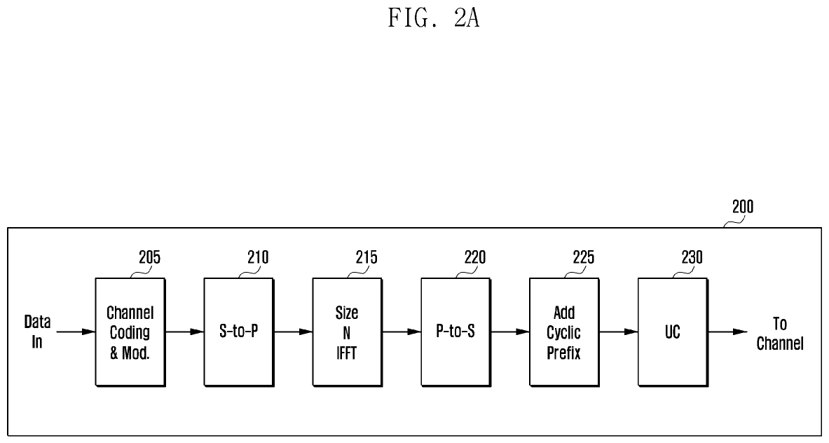

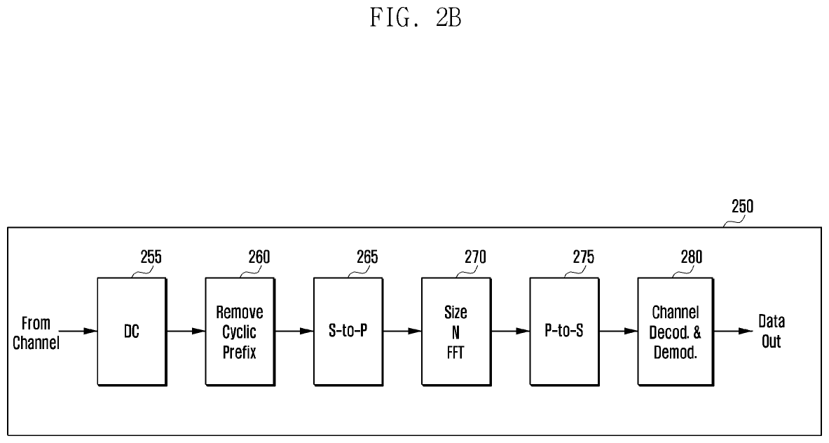

FIGS. 2A and 2B illustrate example wireless transmit and receive paths according to various embodiments of the disclosure.

In the following description, a transmit path 200 may be described as being implemented in a gNB (such as gNB 102), while a receive path 250 may be described as being implemented in a UE (such as UE 116). However, it will be understood that the receive path 250 may be implemented in a gNB and that the transmit path 200 may be implemented in a UE. In some embodiments, the receive path 250 is configured to support the codebook design and structure for systems having 2D antenna arrays as described in embodiments of the disclosure.

The transmit path 200 may include a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 may include a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 may perform an IFFT operation on the N parallel symbol streams to generate time-domain output signals. The parallel-to-serial block 220 may convert (such as multiplexes) the parallel time-domain output symbols from the size N IFFT block 215 in order to generate a serial time-domain signal. The add cyclic prefix block 225 may insert a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 may arrive at the UE 116 after passing through the wireless channel, and reverse operations to those at the gNB 102 are performed at the UE 116. The down-converter 255 may down-convert the received signal to a baseband frequency, and the remove cyclic prefix block 260 removes the cyclic prefix to generate a serial time-domain baseband signal. The serial-to-parallel block 265 may convert the time-domain baseband signal to parallel time domain signals. The size N FFT block 270 may perform an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B may be implemented using only hardware or using a combination of hardware and software/firmware. As a particular example, at least some of the components in FIGS. 2A and 2B may be implemented in software, while other components may be implemented by configurable hardware or a mixture of software and configurable hardware. For example, the FFT block 270 and the IFFT block 215 is implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, may be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B may be combined, further subdivided, or omitted and additional components may be added according to particular needs. Also, FIGS. 2A and 2B are meant to illustrate examples of the types of transmit and receive paths that may be used in a wireless network. Any other suitable architectures may be used to support wireless communications in a wireless network.

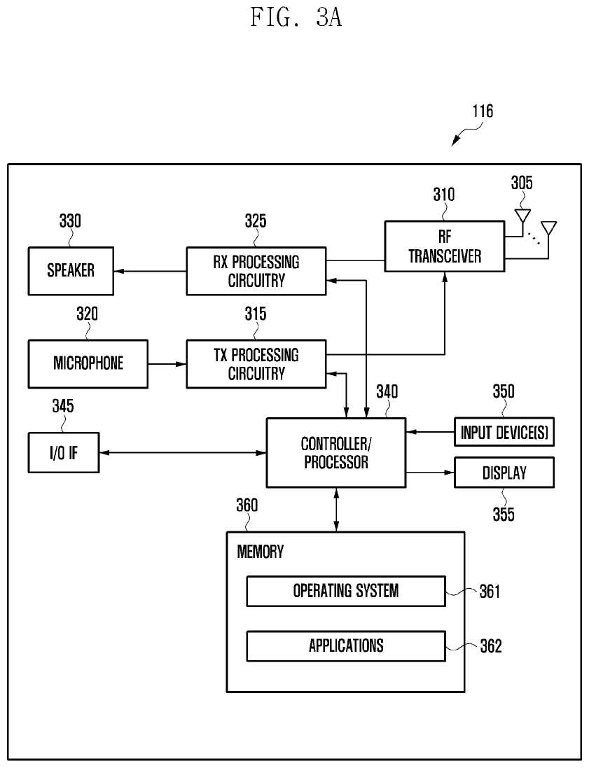

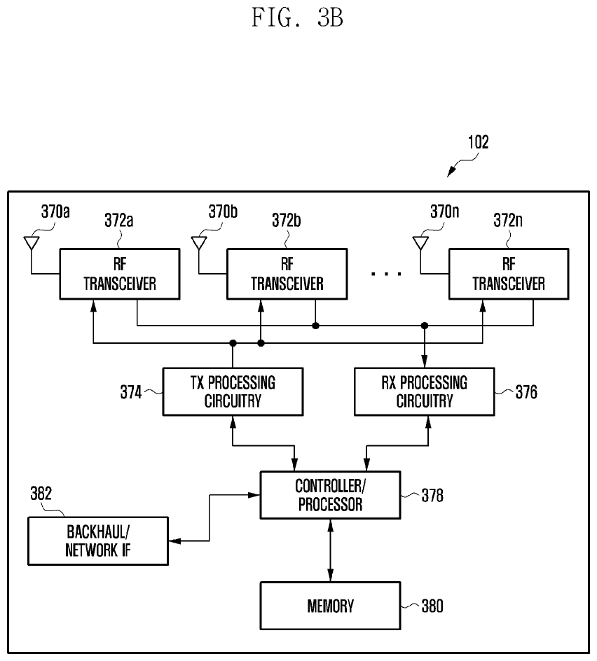

FIG. 3A illustrates an example UE 116 according to an embodiment of the disclosure. The embodiment of the UE 116 illustrated in FIG. 3A is for illustration only, and the UEs 111-115 of FIG. 1 may have the same or similar configuration. However, UEs come in a wide variety of configurations, and FIG. 3A does not limit the scope of this disclosure to any particular implementation of a UE.

Referring to FIG. 3A, the UE 116 may include an antenna 305, a radio frequency (RF) transceiver 310, transmit (TX) processing circuitry 315, a microphone 320, and receive (RX) processing circuitry 325. The UE 116 may also include a speaker 330, a main processor 340, an input/output (I/O) interface (IF) 345, a keypad 350, a display 355, and a memory 360. The memory 360 may include a basic operating system (OS) program 361 and one or more applications 362.

The RF transceiver 310 receives, from the antenna 305, an incoming RF signal transmitted by a gNB of the wireless network 100. The RF transceiver 310 may down-convert the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 may transmit the processed baseband signal to the speaker 330 (such as for voice data) or to the main processor 340 for further processing (such as for web browsing data).

The TX processing circuitry 315 may receive analog or digital voice data from the microphone 320 or other outgoing baseband data (such as web data, e-mail, or interactive video game data) from the main processor 340. The TX processing circuitry 315 may encode, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 may include one or more processors or other processing devices and execute the basic OS program 361 stored in the memory 360 in order to control the overall operation of the UE 116. For example, the main processor 340 controls the reception of forward channel signals and the transmission of reverse channel signals by the RF transceiver 310, the RX processing circuitry 325, and the TX processing circuitry 315 in accordance with well-known principles. In some embodiments, the main processor 340 may include at least one microprocessor or microcontroller.

The main processor 340 is also capable of executing other processes and programs resident in the memory 360, such as operations for channel quality measurement and reporting for systems having 2D antenna arrays as described in embodiments of the disclosure as described in embodiments of the disclosure. The main processor 340 may move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller (i.e., main processor 340).

The main processor 340 is also coupled to the keypad 350 and the display 355. The operator of the UE 116 may use the keypad 350 to enter data into the UE 116. The display 355 may be a liquid crystal display or other display capable of rendering text and/or at least limited graphics, such as from web sites. The memory 360 is coupled to the main processor 340. Part of the memory 360 may include a random access memory (RAM), and another part of the memory 360 may include a Flash memory or other read-only memory (ROM).

Although FIG. 3A illustrates one example of UE 116, various changes may be made to FIG. 3A. For example, various components in FIG. 3A is combined, further subdivided, or omitted and additional components are added according to particular needs. As a particular example, the main processor 340 may be divided into multiple processors, such as one or more central processing units (CPUs) and one or more graphics processing units (GPUs). Also, while FIG. 3A illustrates the UE 116 configured as a mobile telephone or smartphone, UEs may be configured to operate as other types of mobile or stationary devices.

FIG. 3B illustrates an example gNB 102 according to an embodiment of the disclosure. The embodiment of the gNB 102 shown in FIG. 3B is for illustration only, and other gNBs of FIG. 1 may have the same or similar configuration. However, gNBs come in a wide variety of configurations, and FIG. 3B does not limit the scope of this disclosure to any particular implementation of a gNB. It is noted that gNB 101 and gNB 103 may include the same or similar structure as gNB 102.

Referring to FIG. 3B, the gNB 102 may include multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a, and 372b-372n may receive, from the antennas 370a, and 370b-370n, incoming RF signals, such as signals transmitted by UEs or other gNBs. The RF transceivers 372a-372n may down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 may transmit the processed baseband signals to the controller/processor 378 for further processing.

The TX processing circuitry 374 may receive analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n may receive the outgoing processed baseband or IF signals from the TX processing circuitry 374 and up-converts the baseband or IF signals to RF signals that are transmitted via the antennas 370a-370n.

The controller/processor 378 may include one or more processors or other processing devices that control the overall operation of the gNB 102. For example, the controller/processor 378 may control the reception of forward channel signals and the transmission of reverse channel signals by the RF transceivers 372a-372n, the RX processing circuitry 376, and the TX processing circuitry 374 in accordance with well-known principles. The controller/processor 378 may support additional functions as well, such as more advanced wireless communication functions. For instance, the controller/processor 378 may perform the blind interference sensing (BIS) process, such as performed by a BIS algorithm, and decodes the received signal subtracted by the interfering signals. Any of a wide variety of other functions may be supported in the gNB 102 by the controller/processor 378. In some embodiments, the controller/processor 378 may include at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the disclosure. In some embodiments, the controller/processor 378 may support communications between entities, such as web RTC. The controller/processor 378 may move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The network interface 382 may support communications over any suitable wired or wireless connection(s). For example, when the gNB 102 is implemented as part of a cellular communication system (such as one supporting 5G, LTE, or LTE-A), the network interface 382 may allow the gNB 102 to communicate with other gNBs over a wired or wireless backhaul connection. When the gNB 102 is implemented as an access point, the network interface 382 may allow the gNB 102 to communicate over a wired or wireless local area network or over a wired or wireless connection to a larger network (such as the Internet). The network interface 382 may include any suitable structure supporting communications over a wired or wireless connection, such as an Ethernet or RF transceiver.

The memory 380 is coupled to the controller/processor 378. Part of the memory 380 may include a RAM, and another part of the memory 380 may include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) may support communication with aggregation of FDD cells and TDD cells.

Although FIG. 3B illustrates one example of a gNB 102, various changes may be made to FIG. 3B. For example, the gNB 102 may include any number of each component shown in FIG. 3. As a particular example, an access point may include a number of network interfaces 382, and the controller/processor 378 may support routing functions to route data between different network addresses. As another particular example, while shown as including a single instance of TX processing circuitry 374 and a single instance of RX processing circuitry 376, the gNB 102 may include multiple instances of each (such as one per RF transceiver).

Multiple input multiple output (MIMO) system wherein a BS and/or a UE is equipped with multiple antennas has been widely employed in wireless systems for its advantages in terms of spatial multiplexing, diversity gain and array gain.

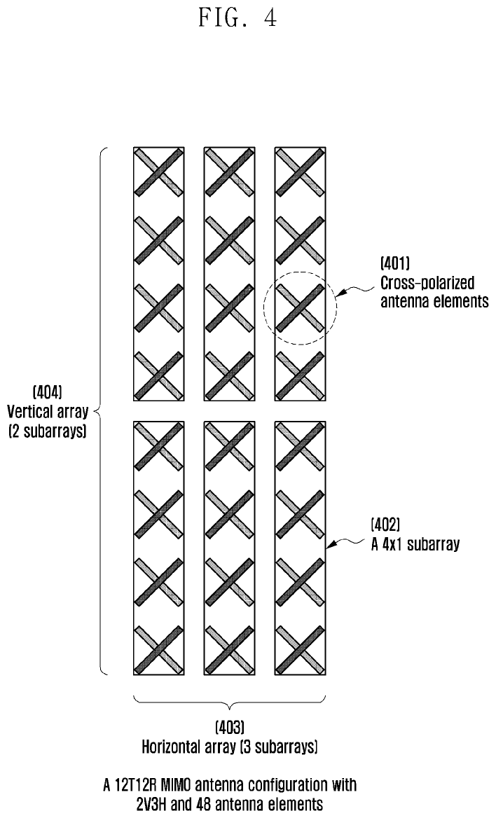

FIG. 4 illustrates an example of MIMO antenna configuration with 48 antenna elements according to an embodiment of the disclosure.

Referring to FIG. 4, 4 cross-polarized 401 antenna elements form a 4×1 subarray 402. 12 subarrays form a 2V3H MIMO antennas configuration consisting 2 and 3 subarrays in a vertical dimension 404 and a horizontal dimension 403, respectively. Although FIG. 4 illustrates one example of MIMO antenna configuration, the disclosed invention may be applied to various such configurations.

In MIMO systems, the channel state information (CSI) is required at the base station (BS) so that a signal from the BS is received at the UE with maximum possible received power and minimum possible interference. The acquisition of CSI at the BS may be via a measurement at the BS from a UL reference signal or via a measurement and feedback by the UE from a DL reference signal for time-domain duplexing (TDD) and frequency-domain duplexing (FDD) systems, respectively. In 5G FDD systems, the channel state information reference signal (CSI-RS) is the primary reference signal that is used by the UE to measure and report CSI.

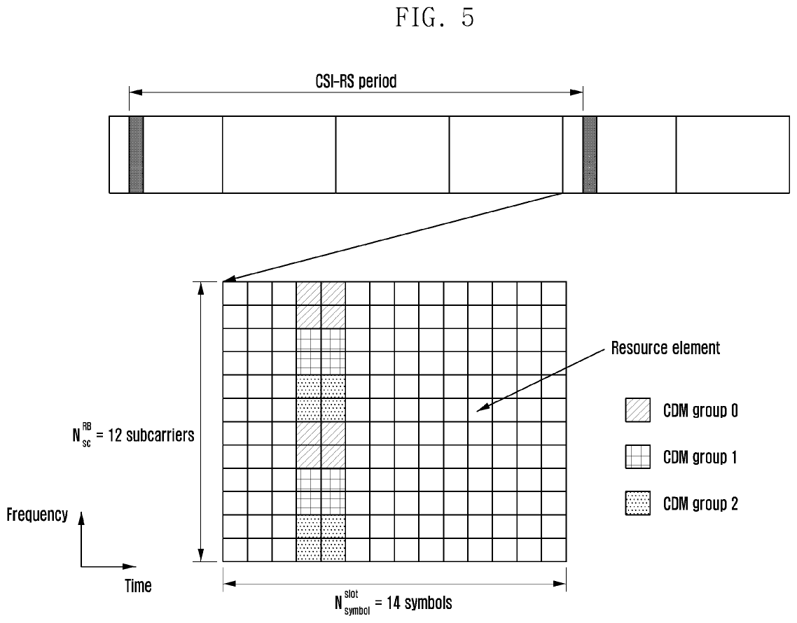

FIG. 5 illustrates a layout for channel state information reference signal (CSI-RS) resource mapping in an orthogonal frequency division multiple access (OFDM) time-frequency grid according to an embodiment of the disclosure.

Referring to FIG. 5, a UE may receive a configuration signaling from a BS for a CSI-RS that may be used for channel measurement. An example of such configuration is illustrated in FIG. 5. 12 antenna ports (CSI-RS ports) are mapped to a CSI-RS with 3 code-domain multiplexing (CDM) groups, wherein each CDM group is mapped to 4 resource elements (REs) in OFDM time-frequency grid. The antenna ports that are mapped to the same CDM group may be orthogonalized in code-domain by employing orthogonal cover codes. The CSI-RS configuration in FIG. 5 may be related to the MIMO antenna configuration in FIG. 4, by mapping a CSI-RS port to one of the polarization of a subarray. In the 5G NR standards, three time-domain configurations, namely: periodic, semi-persistent and aperiodic are possible. In the figure, an illustrative example of periodic configuration is given with a period of 4 slots.

In some embodiments, the BS is capable of configuring a UE, by a higher layer signaling, with information for a CSI feedback that may include spatial channel information indicator and other supplementary information that would help the BS to have an accurate CSI. The spatial channel indicator, which is reported via a precoding matrix indicator (PMI) in 4G and 5G specifications, comprises a single or a plurality of channel matrix, the channel covariance matrix, the eigenvectors, or spatial sampling basis vectors. In particular, in 4G and 5G specification, the spatial channel information may be given by a single or a plurality of discrete Fourier transform (DFT) basis vectors.

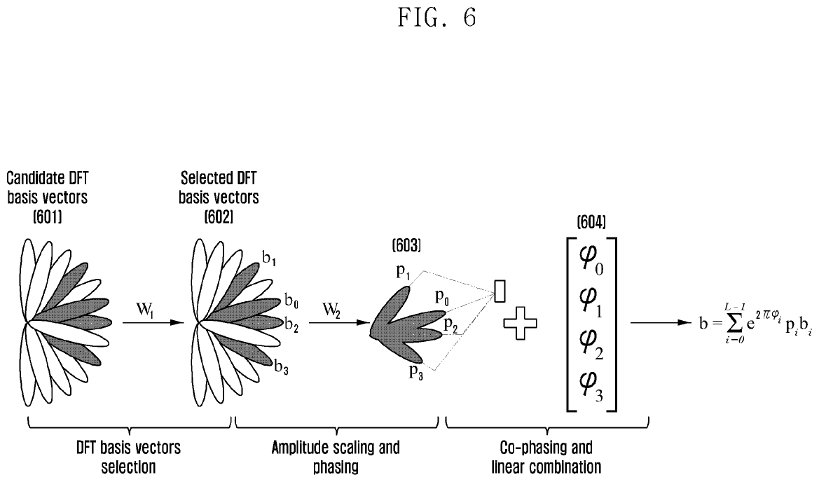

FIG. 6 illustrates an example of CSI feedback based on a plurality of DFT basis vectors for what is known as Type II CSI in 5G NR according to an embodiment of the disclosure.

Referring to FIG. 6, the spatial information of the channel is reported in terms of L=4 DFT basis vectors {b₀, b₁, b₂, b₃} 602 from a set of candidate DFT basis vectors 601. Additionally, amplitude information {p₀, p₁, p₂, p₃} 603 and co-phasing information {φ₀, φ₁, φ₂, φ₃} (604) are reported. Thus, in Type II CSI a dual-stage precoding matrix is given as W=W₁W₂, where, W₁ select the DFT basis vectors and W₂ assign amplitude and co-phasing coefficients. Furthermore, a codebook may be defined as superset of candidate DFT basis vectors as well as candidate amplitude and phase coefficients. Then, a reported PMI would consist of indicators to the elements of a codebook that may represent the estimated channel.

In an embodiment, amplitude and phase information are reported in such a way that the linear combination of the basis vectors, i.e., b=Σᵢ₌₀^{L-1}e^{2πφi}pᵢbᵢ, is matched to the eigenvector direction of the channel. Specifically, for a channel matrix H with the (s, u)—th element h_{s,u} representing the channel gain between the s-th transmit and the u-th receive antenna, the eigenvectors of the covariance matrix H^{H}H may be considered. Let eᵢ denote one of the eigenvectors, then the PMI may be selected by the UE in such a way that the value ∥eₗ^{H}b∥ is maximized.

Moreover, a UE may be configured in different ways to report a tuple of DFT basis vectors, amplitude coefficients and the phase coefficients, based on polarization-common or polarization-specific manner. For example, in 5G NR specifications, DFT basis vectors are reported in a polarization-common manner while phase and amplitude coefficients are reported in polarization specific manner, i.e., reported per polarization. MIMO systems allow spatial multiplexing, i.e., transmission of data in multiple transmission layers. In this regard, the type II CSI in the 5G NR allows the DFT basis vectors to be reported in a layer-common manner, i.e., common basis for all layers, while phase and amplitude coefficients to be reported in a layer-specific manner.

In order to account for the frequency-selectivity of a wideband channel, some embodiments allow various components of the precoding matrix, i.e., components of PMI, to be reported per frequency ranges. In some configurations, the frequency band the UE is configured for DL reception, referred as DL bandwidth part (DL BWP), is partitioned into a set of subbands and the amplitude and/or phases coefficients are reported per a subband manner. In particular, the DL BWP may be partitioned in to subbands with subband size N_{PRB}^{SB} physical resource blocks (PRBs). Then the selected DFT basis vectors may be linearly combined with different weights so that the resulting vector is aligned to the eigenvector of the channel in that subband. Denoting the set of subcarriers in the k-th subband as Fₖ, then the eigenvectors of the averaged covariance matrix

$${C}_{k} = \frac{1}{\vert {F}_{k} \vert} = {Σ}_{f ∈ {F}_{k}} ( {( {H}_{f , k} )}^{H} ( {H}_{f , k} ) )$$

may be considered, where, fϵFₖ are subcarriers in the k-th subband and H_{f,k} is the corresponding channel matrix.

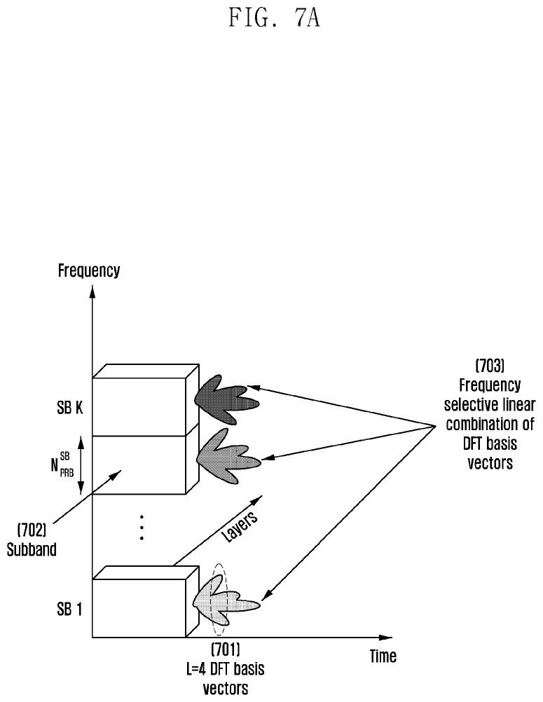

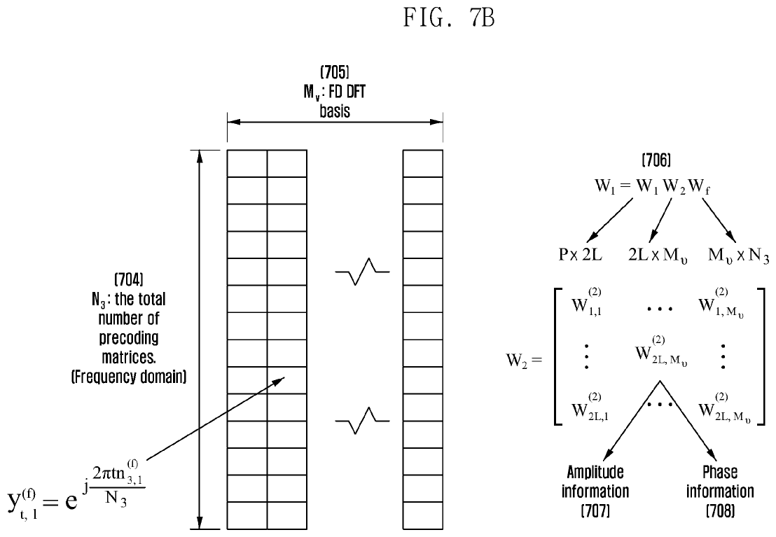

FIG. 7A illustrates exemplary a reporting of precoding matrices in subband granularity according to an embodiment of the disclosure.

FIG. 7B illustrates a precoding matrix construction for enhanced Type II CSI according to an embodiment of the disclosure

Referring to FIGS. 7A and 7B illustrate examples for frequency selective linear combination of DFT basis vectors 703 for K subbands of size N_{PRB}^{SB} 702 over a time 701.

In 5G NR specifications, another configuration, known as enhanced Type II (eType II) CSI, allows reporting amplitude and phase coefficients in a delay-domain rather than per subband reporting in frequency-domain. This configuration may reduce the feedback overhead as the delay components are usually much smaller than the equivalent number of subbands. In enhanced Type II codebook (eType II CB) (FIG. 7B), precoding matrices 704 may be reported in delay domain by employing frequency-domain (FD) DFT basis 705 rather than the frequency domain reporting in Type II CSI (FIG. 7A), i.e., per subband or wideband. FIG. 7B illustrates a construction of eType II CSI. In particular, a precoding matrix is expressed in three-stages W=W₁W₂W_{f}^{H} (706). The spatial domain selection matrix W₁ may select L DFT vectors from P=2N₁N₂ CSI-RS ports, consequently, it has 2L rows accounting for the cross-polarized antennas. Moreover, an Mᵥ×N₃ matrix W_{f}^{H} corresponds to Mᵥ DFT basis vectors that may transform the precoding matrix reported in delay domain for Mᵥ delay components to a frequency domain with N₃ frequency domain points (bins). In particular, the tϵ{1, 2, . . . , N₃}-th element of f-th vector is given by

$${y}_{t , l}^{( f )} = {e}^{j \frac{2 π t {n}_{3 , l}^{( f )}}{{N}_{3}}} .$$

Finally, the matrix W₂ carries the amplitude and phase information wherein the i-th and j-th element, w_{i,j}, carries amplitude (707) and phase (708) information of i-th DFT beam and j-th delay component.

In order to further reduce the CSI overhead, a system may exploit angle-delay reciprocity and measure the dominant angle and delay components of a channel from an UL reference signal such as sounding reference signal (SRS). Then, a precoded CSI-RS may be considered for DL CSI measurement wherein the CSI-RS ports are mapped to an angle-delay component of the channel. Moreover, delay pre-compensation may be applied to the CSI ports so that the UE would measure CSI for a fewer number of delay components, i.e., in the extreme case for just one delay component.

One scenario of interest in wireless communication systems is supporting high and medium mobility UEs. Such mobility shortens the channel coherence time and makes the CSI measurement and feedback challenging.

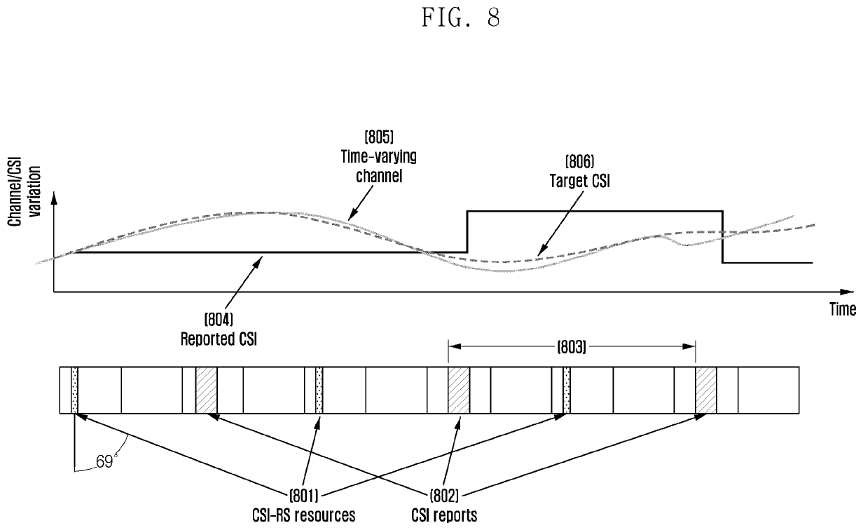

FIG. 8 illustrates channel aging in high and medium mobility scenario according to an embodiment of the disclosure.

Referring to FIG. 8, an illustration of an embodiment wherein a CSI measurement and feedback configuration is given. In the figure a CSI measured from CSI-RSs 801 and reported with CSI reports 802 is illustrated. Moreover, the period between two CSI reports is indicated by 803. The CSI reports that aim at capturing the time-varying channel 805 and the CSI at the gNB may be represented by 804. In the example, it is apparent that there is a discrepancy between the actual time-varying channel 805 and the reported CSI 804. The error between the actual channel and the reported CSI may degrade the system performance and the phenomenon is referred as channel aging or CSI outdating.

To solve the channel aging, a method which enables a CSI to closely follow a time-varying channel as illustrated in 806 is required. One possible solution, to closely capture a time-varying channel, is to increase the measurement and reporting frequency. However, such solutions may not be feasible in some cases as the CSI processing delay between measurement and reporting remains to be a problem. Moreover, the frequent CSI measurement and feedback could also increase the CSI overhead, thus, reducing the efficiency of the wireless communication system.

The following documents and standards descriptions are hereby incorporated into the disclosure as if fully set forth herein:

A description of example embodiments is provided on the following.

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The below flowcharts illustrate example methods that may be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

A typical wireless channel with multiple propagation paths may be modeled as

H_{u,s}(t)=ΣₗA_{u,s,τ}_{ₗ}^{(l)}exp(j(2πf_{τ}_{ₗ}^{(l)}(t−τₗ)+ϕ_{u,s,τ}_{ₗ}^{(l)})) Equation 1

where H_{u,s}(t) is the channel gain between the u-th receive and s-th transmit antenna at time t. Moreover, A_{u,s,τ}_{ₗ}^{(l)}, ϕ_{u,s,τ}_{ₗ}^{(l)}, and f_{τ}_{ₗ}^{(l)} denote the amplitude, phase and Doppler coefficients associated with the l-th propagation path, respectively. The l-th propagation path is associated with a delay τₗ. According to the channel model in (1), the time-variation of the channel is a result of the Doppler component. In the 4G and 5G specifications, while a UE measures and reports CSI, it implicitly assumes the Doppler coefficients (frequencies) to be zero, hence, the CSI reports contain only amplitude and phase information for angular (spatial) and delay (frequency) components of a channel.

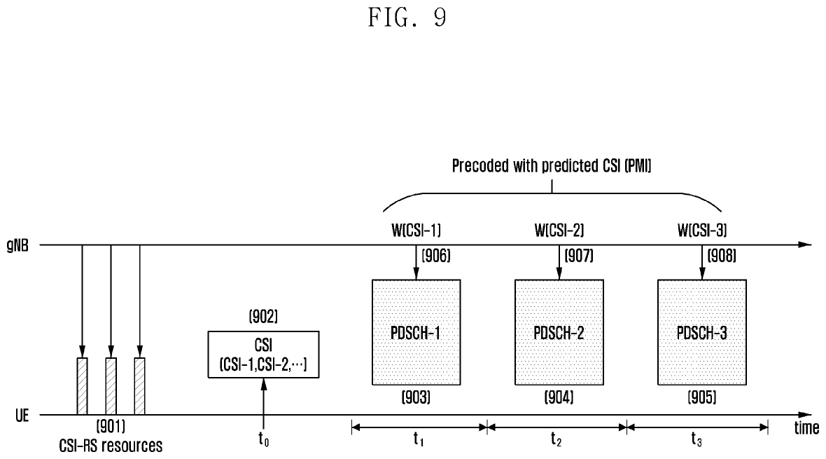

FIG. 9 depicts an embodiment for disclosure wherein a UE reports multiple CSI that may be applied to multiple application time according to an embodiment of the disclosure.

In some embodiments of the disclosure, an RX processing circuitry 325 of a UE is capable of measuring the Doppler coefficients. In this case, the UE is able to report at least one or a plurality of future CSI reports. This is typically important in the medium/high mobility scenarios where the Doppler frequency cannot be ignored.

Referring to FIG. 9, a UE derives multiple CSI reports 902 from at least one CSI-RS resources (901) wherein the each of the CSI reports is applied by gNB in distinct future application time (903), (904), and (905). In an embodiment, a UE may be configured to report N CSI reports {CSI-1, CSI-2, . . . , CSI−N} in (906, (907) and (908). The gNB then precodes the PDSCH transmissions in the time intervals {t₁, t₂, . . . , t_{N}} where CSI-1 is used to precode the PDSCH(s) scheduled in time interval t₁, CSI-2 is used to precode the PDSCH(s) scheduled in time interval t₂ and so on.

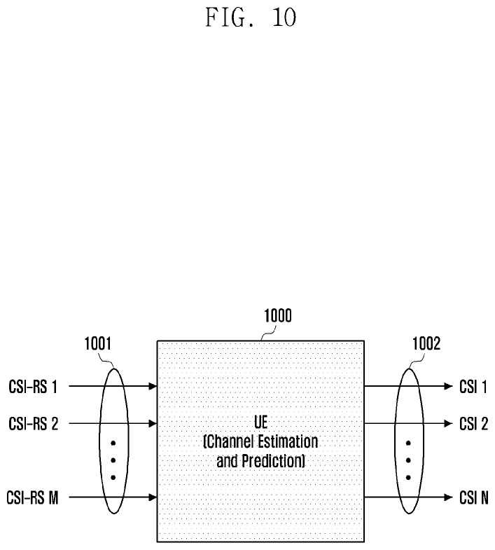

FIG. 10 provides an illustration of one possible realization according to an embodiment of the disclosure.

Referring to FIG. 10, a channel estimation and prediction unit 1000 located inside the UE uses one or more CSI-RS resources 1001 to derive multiple CSI reports for future time intervals 1002. In a realization, M CSI-RS resources in 1001 are received by the UE at different times. Then, the channel estimation and prediction unit 1000 may derive N predicted CSI values wherein each CSI in the N CSI values may be applied at distinct future time.

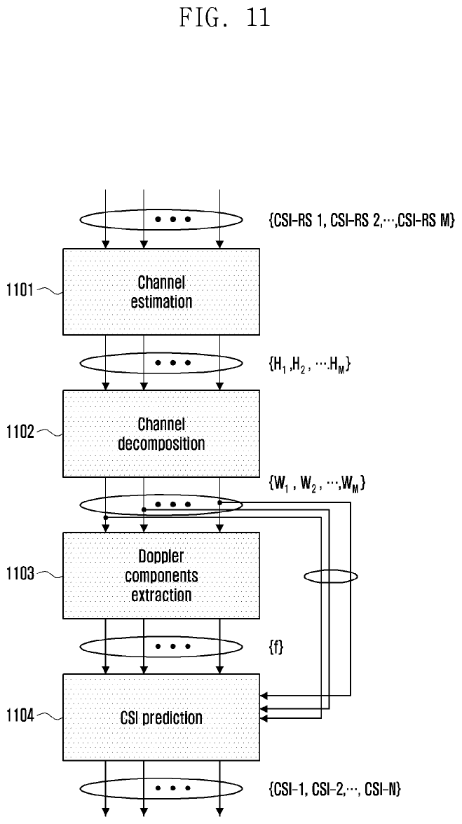

FIG. 11 illustrates a process for channel prediction according to an embodiment of the disclosure.

Referring to FIG. 11, one way to realize the channel estimation and channel prediction unit 1000 is illustrated in FIG. 11. A channel estimation subblock estimates multiple channel matrices {H₁, H₂, . . . , H_{M}} from M CSI-RS resources in subblock 1101. The channel matrices are then decomposed either to reignvector based precoders or to multi-path components as Equation 1 or a linear combination of DFT basis vectors in a similar manner as shown in FIG. 6. The subblock 1103 may then extract the Doppler components (frequencies) based on the outputs of 1102. Finally, the CSI prediction subblock in 1104 derives N predicted CSIs based on the outputs of 1102 and 1103.

Yet another possible implementation of the channel estimation and prediction unit 1000 is based on artificial intelligence (AI). Exploiting their ability in performing non-linear optimization tasks with low computational complexity, deep-learning (DL)-based methods may compute N CSI from channel measurement from M CSI-RS resources.

Part I: Resource and Report Configurations

To enable a UE to estimate and predict CSI feedbacks that may be applied at the future times, the gNB may configure the UE with higher layer parameters.

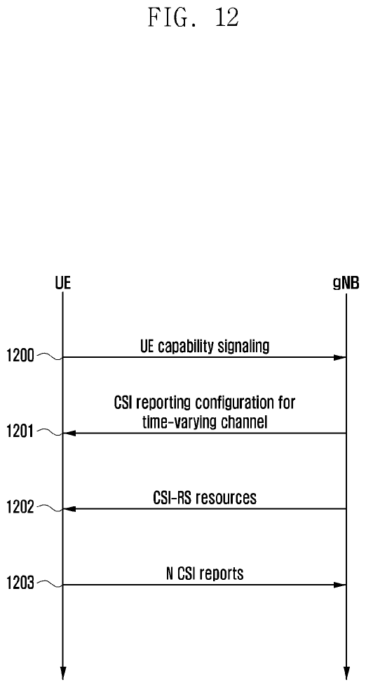

FIG. 12 illustrates a message exchange and signaling for UE capability reporting and RRC configuration to enable time-correlated CSI reporting according to an embodiment of the disclosure.

Referring to FIG. 12 a message exchange in the disclosure is illustrated. A UE capability signaling 1200 may indicate to the gNB on the UE's capability of reporting predicted CSI from at least one or more CSI-RS resources. The gNB then configures the UE with a higher layer configuration 1201 for resource and report configurations. As an example, the disclosure introduces a CSI report configuration wherein a parameter timeCorrelatedCSI as shown below configures the UE to report predicted CSI reports. The UE then may measure at least one or more CSI-RS resources 1202. Moreover, the UE reports the N≥1 CSI reports (1203) that may be applied at N future application times.

CSI-ReportConfig ::= SEQUENCE {
reportConfigId CSI-ReportConfigId,
carrier ServCellIndex OPTIONAL, -- Need S
resourcesForChannelMeasurement CSI-ResourceConfigId,
csi-IM-ResourcesForInterference CSI-ResourceConfigId OPTIONAL, --
Need R
nzp-CSI-RS-ResourcesForInterference CSI-ResourceConfigId OPTIONAL,
-- Need
R
reportConfigType CHOICE {
periodic SEQUENCE {
reportSlotConfig CSI-ReportPeriodicityAndOffset,
...
....
....
timeCorrelatedCSI ENUMERATED {enabled} OPTIONAL

Part I.1 Resource Configurations

One method, Method I.1.1, configures a UE with a resource configuration for CSI prediction which allow the UE to derive the CSI reports from a single resource set. When a UE is configured with CSI-ReportConfig wherein the parameter timeCorrelatedCSI is enabled and the reportQuantity is set to either ‘cri-RI-PMI-CQI’, or ‘cri-RI-LI-PMI-CQI’, then the UE derives the CSI based on all CSI-RS resources in the associated CSI-RS resource set for channel measurement and cri is not reported.

In a yet another Method I.1.2, a higher layer parameter may subselect CSI-RS resources from a CSI-RS resources set. In the disclosure, a new higher layer parameter namely M-bundledCSI is introduced. The higher-layer parameter M-BundledCSI-RS subselects M CSI-RS resources from a resource set with Kₛ CSI-RS resource sets. When a UE is configured with a CSI-ReportConfig wherein the parameter timeCorrelatedCSI is enabled and a reportQuantity is set to either ‘cri-RI-PMI-CQI’, or ‘cri-RI-LI-PMI-CQI’, and the parameter M-BundledCSI-RS is configured then the UE derives the CSI based on all CSI-RS resources selected by M-BundledCSI-RS from the associated CSI-RS resource set for channel measurement, and cri is not reported.

NZP-CSI-RS-ResourceSet ::= SEQUENCE {
nzp-CSI-ResourceSetIdNZP-CSI-RS-ResourceSetId,
nzp-CSI-RS-Resources SEQUENCE (SIZE (1..maxNrofNZP-
CSI-RS-
ResourcesPerSet)) OF NZP-CSI-RS-ResourceId,
repetition ENUMERATED { on, off } OPTIONAL, -- Need S
aperiodicTriggeringOffset INTEGER(0..6) OPTIONAL, -- Need S
trs-Info ENUMERATED {true} OPTIONAL, -- Need R
...,
[[
aperiodicTriggeringOffset-r16 INTEGER(0..31) OPTIONAL -- Need S
]]
}
M-Bundled-CSI-RS CHOICE {1... maxNrofNZP-CSI-RS-
ResourcesPerSet }
OPTIONAL
numberOfCorrelatedCSI CHOICE {1...
maxNumberOfCorrelatedCSI }
OPTIONAL

As another method, Method I.1.3, of the disclosure, dynamic subselection via dynamic signaling such as dynamic control information (DCI) or medium access control-control element (MAC-CE). As an example, from a CSI-RS resource set that contains Kₛ CSI-RS resources, a dynamic indicator may subselect M of them for measurement so that the UE may derive the time-varying CSI. When a UE is configured with CSI-ReportConfig wherein the parameter timeCorrelatedCSI is enabled and reportQuantity is set to either ‘cri-RI-PMI-CQI’, or ‘cri-RI-LI-PMI-CQI’ and an aperiodic CSI report is triggered by a DCI then the UE derives the CSI based on the CSI-RS resources for channel measurement in the associated CSI-RS resource set as indicated by triggering DCI, and cri is not reported.

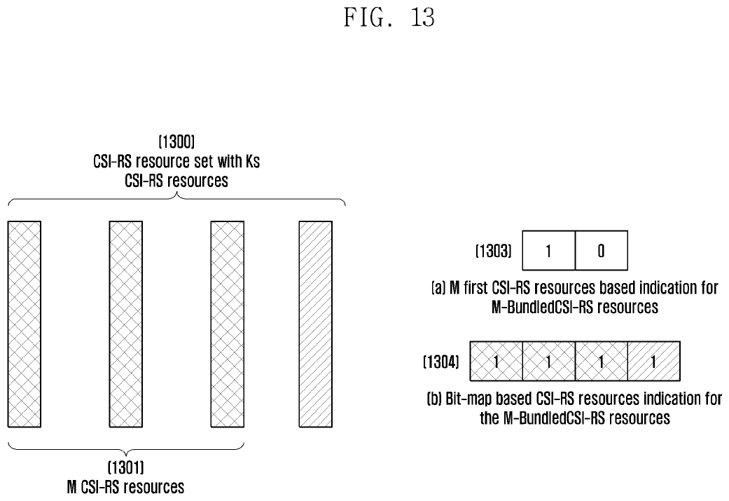

FIG. 13 illustrates a configuration of CSI-RS resources that may be used to derive time-correlated CSI according to an embodiment of the disclosure.

Referring to FIG. 13, a higher layer parameter may configure Kₛ=4 CSI-RS resources (1300). An RRC, MAC-CE or DCI based subselection according to embodiments I.1.2-I.1.3 selects M=3 (1301) of the CSI-RS resources. Furthermore, as part of Method I.1.2-I.1.3., the selection of the M CSI-RS resources may be indicated by an indicator (1303) with a bitwidth ┌log₂(Kₛ−1)┐ wherein a value m−1 is interpreted as the first m CSI-RS resources in a resource set are considered to derive the CSI reports. Another part of Method I.1.2-I.1.3. the selection of the M CSI-RS resources may be indicated by a bit-map indicator (1304) with a bitwidth Kₛ wherein if the m-th bit is set to 1 then the m-th CSI-RS resource in the CSI-RS resources set is considered to derive the CSI reports.

In order to avoid an introduction of random phase noise while the UE measures channel from the CSI-RS resources in the M CSI-RS resources for time-correlated CSI measurement, the UE may avoid switching to UL transmission or change the receiver filter or making power adjustment during the time that spans from the first OFDM symbol of the first CSI-RS resource to the last symbol of the last CSI-RS resource in the M CSI-RS resource.

Another restriction, an embodiment may restrict the reception of the M CSI-RS resources in K=1,2 consecutive slots. This way the buffer requirement to store the channel estimates may be restricted. As a yet another Method I.1.4, a UE may report on its capability on deriving time-correlated CSI from CSI resources received within N₁=2, 3, 4 . . . consecutive slots.

Part II: CSI Reporting Based on Different Codebooks

Part: Report Based on Type I CSI

In this subsection, the description of the disclosure is discussed with respect to Type I CSI in the 5G NR system. In Type I single panel codebook (Type I SP CB), a UE reports indicators i₁ and i₂. The UE may be configured with higher layer parameter codebookMode which may be set to either ‘1’ or ‘2’.

When the codeboodMode is set to ‘1’, the indicator i₁ which may include sub-indicators i_{1,1}, i_{1,2} and/or i_{1,3}, i.e., i₁={i_{1,1}, i_{1,2}, i_{1,3}} or i₁={i_{1,1}, i_{i,2}, i_{1,3}}, where it indicates the spatial channel information. On the other hand, the other indicator i₂ indicates co-phasing coefficient. The spatial channel information includes a 2-dimensional (2D) DFT vector spatial basis vector given as

$${v}_{l , m} = {[ \begin{matrix}{u}_{m} & {e}^{j \frac{2 π l}{{O}_{1} {N}_{1} {u}_{m}}} & … & {e}^{j \frac{2 π l ( {N}_{1} - 1 )}{{O}_{1} {N}_{1}}} & {u}_{m}\end{matrix} ]}^{T} \qquad Equation 2$$

where

$${u}_{m} = \{ \begin{matrix}{[ 1 {e}^{j \frac{2 π m}{{O}_{1} {N}_{1}}} … {e}^{j \frac{2 π m ( {N}_{1} - 1 )}{{O}_{1} {N}_{1}}} ]}^{T} & {N}_{2} \geq 1 \\ 0 & {N}_{2} = 1\end{matrix}$$

and the antenna array dimensions N₁ and N₂ with the corresponding oversampling factors O₁ and O₂ are configured via higher layer parameters. The components of i₁, i.e., indicators i_{1,1}, i_{1,2} or i_{1,3} which are mapped to the values l and m which may then be used to construct v_{l,m}. Moreover, a co-phasing information is indicated via indicator i₂ which is mapped to a value n which is in turn mapped to a co-phasing coefficient φₙ=e^{jπn/2}. The spatial and co-phasing information may then be used by the gNB to construct the precoder associate to a particular layer as

$$[ \begin{matrix}{v}_{l , m} \\ \pm {φ}_{n} {v}_{l , m}\end{matrix} ] .$$

In one method, Method II.1.1, of the disclosure, a UE may derive N co-phasing coefficients that may be applied in a corresponding N future application time intervals. The time intervals may be defined with the granularity of slots, subframes, symbols or other units of time. In particular, when a UE is configured with higher layer parameter codebookType set to ‘typeI-SinglePanel’ and the parameter timeCorrelatedCSI in the CSI report configuration is enabled, each PMI value corresponds to a codebook indicator i₁ and N distinct codebook indicators i₂, i.e., i₂={i_{2,1}, i_{2,2}, . . . , i_{2,N}} where the value N is configured by a newly introduced higher layer parameter numberOfCorrelatedCSI. Moreover, i_{2,t} along the reported i₁ is used by gNB to construct the precoder in the application time tϵ{1,2, . . . , N}.

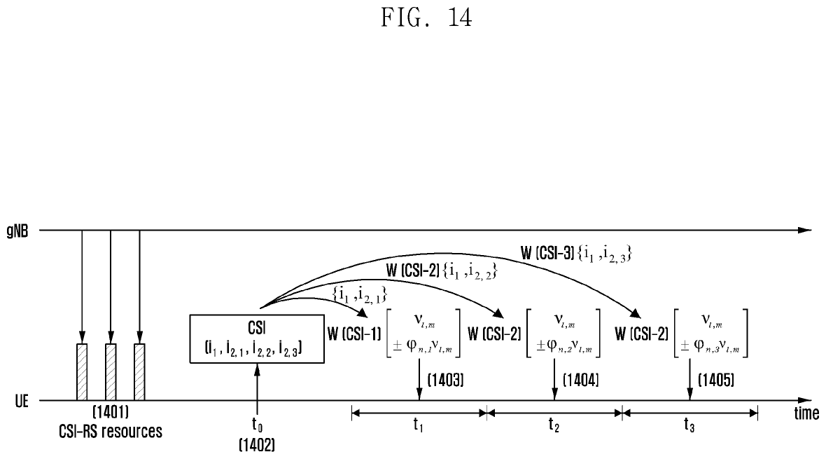

FIG. 14 illustrates a time-correlated CSI reporting for Type I CSI according to an embodiment of the disclosure.

An illustration of embodiment II.1 is provided in FIG. 14.

Referring to FIG. 14, the UE which is configured with a bundled CSI-RS resource(s) (1401) derives time correlated CSI report (1402) which contains a single spatial information indicator i₁ and N=3 co-phasing indicators {i_{2,1}, i_{2,2}, i_{2,3}}. Upon receiving the time correlated CSI report (1402), the gNB derives the corresponding precoders (1403), (1404) and (1405) for the corresponding application time intervals t=1, 2, 3. In particular, for application time t the gNB may utilize the reported indicators {i₁, i_{2,t}}

In a yet another method, Method II.1.2, of the disclosure, the UE derives N−1 additional Doppler co-phasing correction coefficients that may be applied in the future additional N−1 application time intervals in addition to an application time interval that does not require correction. The time intervals may be defined with the granularity of slots, subframes, symbols or other units of time. In particular, when a UE is configured with higher layer parameter codebookType set to ‘typeI-SinglePanel’ and the parameter timeCorrelatedCSI in the CSI report configuration is enabled, each PMI value corresponds to a codebook indicators {i₁, i₂} and additional Doppler co-phasing correction indicator with N−1 sub-indicators, i.e., i₃={i_{3,1}, i_{3,2}, . . . , i_{3,N-1}}. An embodiment may introduce a higher layer parameter termed as numberOfCorrelatedCSI to configure the UE with the value N. Moreover, the sub-indicator i_{3,t} along the reported i₁ and i₂, is used by gNB to construct the precoder in the application time tϵ{2, 3, . . . , N}. Moreover, the Doppler co-phasing correction information indicated via a sub-indicator i_{3,t} may be mapped to a value n′ which is in turn mapped to a co-phasing coefficient ϕₙ=e^{jπn′/2}. The spatial, co-phasing and Doppler co-phasing correction information may then be used to construct the precoder associate to a particular layer as

$$[ \begin{matrix}{v}_{l , m} \\ \pm {ϕ}_{{n}^{′}} {φ}_{n} {v}_{l , m}\end{matrix} ] .$$

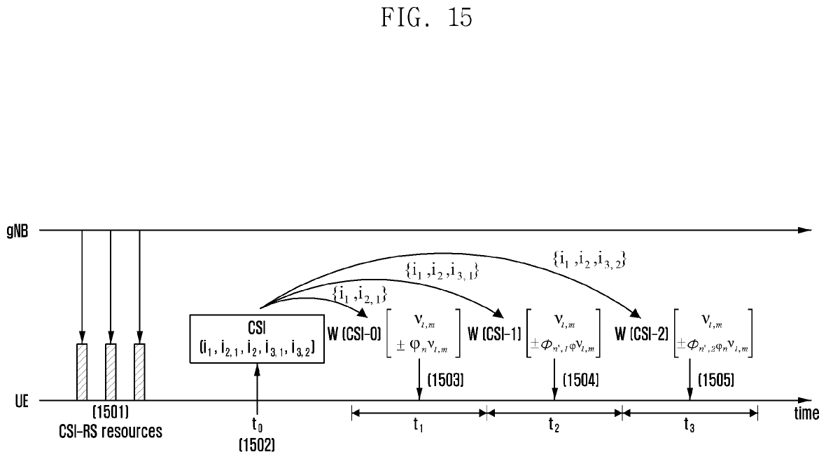

FIG. 15 illustrates a time-correlated CSI reporting for Type I CSI with Doppler co-phasing correction coefficients according to an embodiment of the disclosure.

An illustration of embodiment 11.2 is provided in FIG. 15. Referring to FIG. 15, the UE which is configured with a bundled CSI-RS resource(s) (1501) derives time correlated CSI report (1502) which contains a single spatial information indicator i₁, a co-phasing indicator i₂ and N−1=2 Doppler co-phasing correction indicators {i_{3,1}, i_{3,2}}. The CSI-RS resource(s) in 1502 may be non-zero CSI-RS resources for channel measurement or CSI-RS resources for tracking. Upon receiving the time correlated CSI report (1502), the gNB derives the corresponding precoders (1503), (1504), and (1505) for the corresponding application time intervals t=1, 2, 3. In particular, for application time t=2, 3, the gNB may utilize the reported indicators {i₁, i₂} and {i_{3,t}}.

One additional consideration in reporting a CSI feedback is the CSI reporting frequency granularity. In the 5G NR system, a UE may be configured with a higher layer parameter pmi-FormatIndicator which may be set as “widebandPMI” or “subbandPMI”. When the UE is configured with pmi-FormatIndicator set to “subbandPMI”, the UE reports a single wideband indicator i₁ for the entire CSI reporting band and distinct subband indicators i₂ for each subband in the CSI reporting band. An embodiment based on the disclosure may assume a single Doppler co-phasing correction coefficient indicator i₃ for the entire CSI reporting band. In a yet another variant of the disclosure, a UE may report the Doppler Co-phasing correction indicator i₃ is reported per each subband in the CSI reporting band. To enable this, an embodiment of the disclosure, may introduce a new higher layer subbandDopplerCorrection. However, in order to manage the CSI reporting overhead, the Doppler co-phasing correction may be reported in wideband.

Part II.2: Report Based on Type II CSI

In this subsection, the description of the disclosure is provided by exemplifying it with respect to Type II CSI in the 5G NR system. In Type II codebook (Type II CB), a UE reports indicators i₁ and i₂. The indicator i₁ which may include sub-indicators i_{1,1}, i_{1,2}, i_{1,3,l}, i_{1,4,l} where lϵ{1,2} is a layer indicator, indicates the spatial channel information and the corresponding wideband amplitude coefficients. On the other hand, another indicator i₂ indicates subband amplitude and co-phasing coefficients. In Type II CSI, the spatial channel information includes L 2-dimensional (2D) DFT vectors wherein each member of the L vectors, denoted as v_{l,m}, is given as per Equation 2. The value of L is configured by a higher layer parameter numberOfBeams. The components of i₁ which are reported in a wideband manner cover the entire CSI reporting band. Moreover, the indicator i₂ may be reported in either a wideband or subband manner. If it is reported in a subband manner, it indicates co-phasing and subband amplitude information otherwise it indicates only a co-phasing information. The gNB then makes a precoder for layer l based on the reported PMI as

$${W}^{l} = \frac{1}{\sqrt{{N}_{1} {N}_{2} {Σ}_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L}\end{matrix} ] \qquad Equation 3$$

where the L 2D-DFT vectors {vₘ_{₁}_{⁽¹⁾}_{,m}_{₂}_{⁽²⁾}}ᵢ₌₀^{L-1} and the 2L−1 wideband amplitude coefficients {p_{l,i}⁽¹⁾}ᵢ₌₀^{2L-1} are reported via {i_{1,1},i_{1,2}} and i_{1,4,l}, respectively. Moreover, the subband amplitude coefficients {p_{l,1}⁽²⁾}ᵢ₌₀^{2L-1} and phase coefficients {φ_{l,i}⁽²⁾}ᵢ₌₀^{2L-1} are reported via the sub-indicators i_{2,2,l} and i_{2,1,l}, respectively.

In one method, Method II.2.1, of the disclosure, a UE derives N co-phasing factors that may be applied in the future N application time intervals when a UE reports a CSI report for time-correlated CSI. The time intervals may be defined with a granularity of slots, subframes, symbols or other units of time. In particular, when a UE is configured with higher layer parameter codebookType set to ‘typeII’ or ‘typeII-PortSelection’ and the parameter timeCorrelatedCSI in the CSI report configuration is enabled, each PMI value corresponds to a codebook indicator i₁ and/or the subband amplitude coefficient i_{2,2,l} and N co-phasing coefficients {i_{2,2,t,l}}ₜ₌₁^{N} that may be applied for application time index t=1, 2, . . . , N. Moreover, i_{2,2,t,l} along the reported i₁, and the other components of i₂ is used by gNB to construct the precoder in the application time tϵ{1, 2, . . . , N}. In this example of the disclosure, therefore, the spatial information of the reported CSI is kept the same across the time intervals t=1, 2, . . . , N while only the co-phasing information is changing and reported by the values {i_{2,2,t,l}}ₜ₌₁^{N}. Method II.2.1 has advantage over reporting N independent CSI in terms of CSI overhead.

In a yet another embodiment of the disclosure, Method II.2.2, a UE derives N−1 additional Doppler co-phasing correction coefficients that may be applied in the future additional N−1 application time intervals in addition to a reference application time interval which does not require correction. The time intervals may be defined with the granularity of slots, subframes, symbols or other units of time. In particular, when a UE is configured with a higher layer parameter codebookType set to ‘type II” and the parameter timeCorrelatedCSI in the CSI report configuration is enabled, each PMI value corresponds to a codebook indicator i₁ and i₂ are reported to the reference application time t=0 while a layer specific additional Doppler co-phasing correction coefficients indicators i_{3,1} where each indicator consists of N−1 sub-indicators, i.e., i_{3,l}={i_{3,1,l}, i_{3,2,l}, . . . , i_{3,N-1,l}}. In particular, the sub-indicator i_{3,t,l} along the reported i₁ and i₂, is used by gNB to construct the precoder in the application time tϵ{2, 3, . . . , N}. Moreover, the Doppler co-phasing correction information indicated via a sub-indicator i_{3,t,l} be mapped to a value n′ which is in turn is mapped to a co-phasing coefficient ϕ_{l,i,t}=e^{jπn′/2}. The spatial, co-phasing and Doppler co-phasing correction information may then be used to construct the precoder associated to a particular layer at an application time t denoted as W^{l}(t) is given as:

$${W}^{l} ( t ) = \frac{1}{\sqrt{{N}_{1} {N}_{2} {Σ}_{i = 0}^{2 L - 1} {( {p}_{l , i}^{( 1 )} {p}_{l , i}^{( 2 )} )}^{2}}} [ \begin{matrix}{\sum }_{i = 0}^{L - 1} {v}_{{m}_{1}^{( i )} , {m}_{2}^{( i )}} {p}_{l , i}^{( 1 )} {p}_{l , i}^{( 2 )} {φ}_{l , i} {ϕ}_{l , i , t} \\ {\sum }_{i = 0}^{L - 1} {v}_{{m}_{1}^{( i )} , {m}_{2}^{( i )}} {p}_{l , i + L}^{( 1 )} {p}_{l , i + L}^{( 2 )} {φ}_{l , i + L} {ϕ}_{l , i , t}\end{matrix} ] \qquad Equation 4$$

The above equation is given as a specific example on how the disclosure may be applied to the case when a UE is configured with a codebook configuration set as ‘typeII’. However, without loss of generality, when the UE is configured to a codebook type ‘typeII-PortSelection’, the disclosure including Method II.2.1 and Method II.2.2 may be applied in a straightforward manner. For example, in the case wherein a UE is configured to codebook type set to ‘typeII-PortSelection’, Equation 4 is modified by replacing the spatial basis vectors {vₘ_{₁}_{⁽ⁱ⁾}_{,m}_{₂}_{⁽ⁱ⁾}} with the appropriate vectors that corresponds to the selected CSI-RS ports.

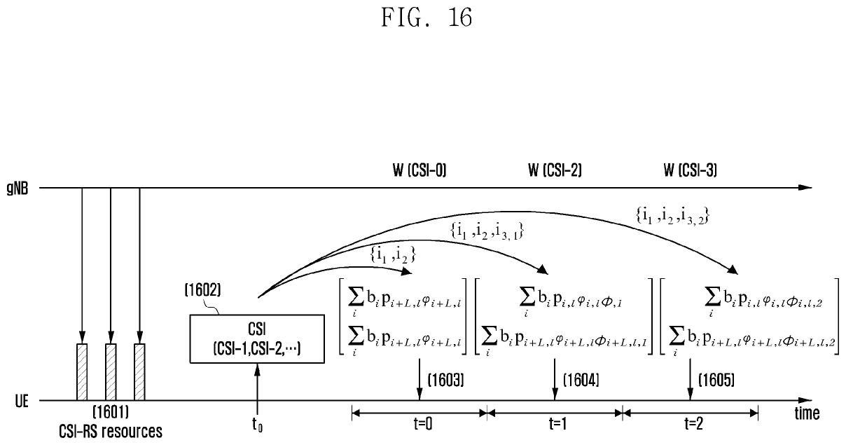

FIG. 16 illustrates an example of embodiment II.2.2 with N=2 according to an embodiment of the disclosure.

Referring to FIG. 16, a UE derives a CSI which contains a reference CSI, CSI-0, and N=2 additional CSI with Doppler co-phasing correction coefficients {i_{1,3,t}}ₜ₌₁². The gNB may derive the precoders for the reference application time t=0 (1603) as the legacy typeII CSI, i.e., based on the indicators {iᵢ, i₂}. Additionally, the Doppler co-phasing correction information indicated via {i_{1,3,t}}ₜ₌₁² may be used by gNB to derive precoders (1604) and (1605) for application time t=1, 2. Thus, additional Doppler co-phasing correction coefficients ϕ are used to construct the precoders in addition to beam b, amplitude coefficients p and co-phasing coefficients φ. Reference marks 1601, 1602 and 1603 are similar to 1501, 1502 and 1503 and as such the definition thereof is omitted.

Another consideration for Method II.2. is that reporting of the Doppler co-phasing correction coefficients may be just for the subset of coefficients rather than to all coefficients. In one sub-embodiments that may be applied to both embodiment II.2.1 and II.2.1, the indicator i_{3,l,t} corresponds to K⁽³⁾ weakest/strongest coefficients determined by the wideband amplitude indicator i_{1,4,l}. If the number of nonzero amplitude coefficients are reported by the UE as Mₗ, then the Doppler co-phasing correction coefficients indicator i_{3,l,t} corresponds to min(K⁽³⁾,Mₗ) weakest/strongest coefficients as determined by the wideband amplitude indicator i_{1,4,l}. The value of K⁽³⁾ can be RRC configured or hard configured in the specification.

CodebookConfig ::= SEQUENCE {
codebookType CHOICE {
.
.
.
type2 SEQUENCE {
subType CHOICE {
typeII SEQUENCE {
.
.
.
typeII-RI-Restriction BIT STRING (SIZE (2))
},
typeII-PortSelection SEQUENCE {
portSelectionSamplingSize ENUMERATED {n1, n2, n3, n4} OPTIONAL,
-- Need
R
typeII-PortSelectionRI-Restriction BIT STRING (SIZE (2))
}
},
phaseAlphabetSize ENUMERATED {n4, n8},
subband Amplitude BOOLEAN,
numberOfBeams ENUMERATED {two, three, four}
dopplerUpdatedCoeffcients ENUMERATED {two, three, four, six}
OPTIONAL

To further reduce the CSI overhead associated with reporting the Doppler correction coefficients, the reported coefficients of i_{3,l}_{_{,t}} may be further reduced. In an embodiment, a UE may correct/update the co-phasing coefficients only for a subset of DFT vectors per application time.

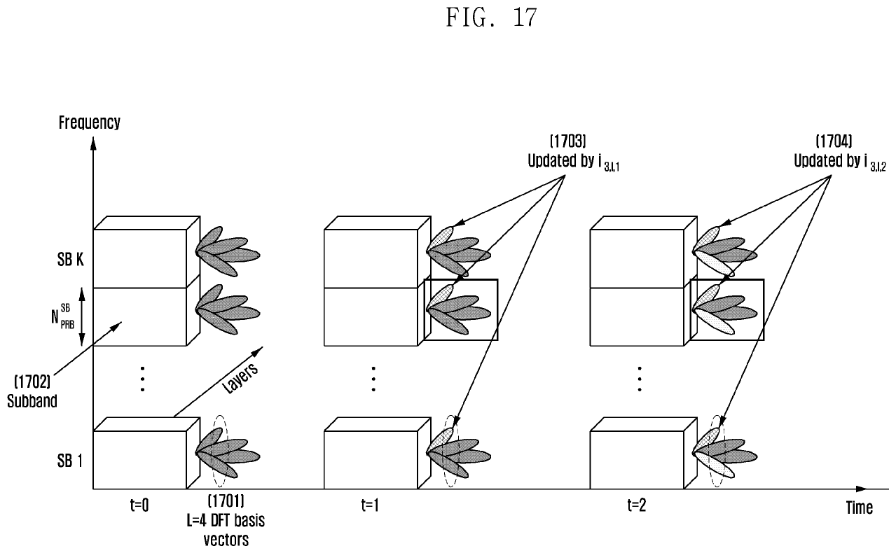

FIG. 17 illustrates a time-correlated CSI reporting with subset of spatial basis according to an embodiment of the disclosure.

FIG. 17 gives a pictorial example for updating a subset of DFT vectors. Referring to FIG. 17, the UE derives the typeII CSI based on L=4 DFT vectors (1701). The amplitude and phase information are reported per subband manner. In the application time t=0 (1701), the reference CSI based on the legacy typeII CSI, indicated based on {i₁, i₂} is considered. In time t=1, the Doppler co-phasing correction is reported via i_{3,l,1} for weakest single DFT vector (1703) rather than all DFT vectors. In other words, i_{3,l,1} belongs to the weakest DFT vector as determined by the wideband amplitude coefficients i_{1,4,l} that has not been updated/corrected recently. Similarly, at t=2 (1704) the next weakest DFT vector among the recently not updated/corrected DFT vectors, is updated. The UE may be configured with a new RRC parameter, e.g., dopplerUpdatedCoeffcients as shown above, on the number of DFT beams that are updated per application time.

Part II.3: Report Based on Enhanced Type II CSI

In this subsection, the description of the disclosure is provided by exemplifying it with respect to Enhanced Type II CSI in the 5G NR system. In the Enhanced Type II codebook (eType II CB), a UE reports indicators i₁ and i₂. The indicator i₁ which may include sub-indicators i_{1,1}, i_{1,2}, i_{1,5}, i_{1,6,l}, i_{1,7,l}, i_{1,8,l}, for transmission layers lϵ{1,2,3,4}, indicates the spatial channel information (spatial basis) and the frequency domain (FD) basis information. In particular, the indicators i_{1,1} and i_{1,2} select and indicate spatial basis (2L 2D-DFT beams) whereas i_{1,5} and i_{1,6,l} select Mᵥ FD basis. Furthermore, the subindicator i_{1,7,l} indicates the position of nonzero coefficients from 2L×Mᵥ elements of W₂ (706) and i_{1,8,l} indicates the strongest coefficient of layer l. Moreover, the indicator i₂ consisting subindicators i_{2,3,l}, i_{2,4,l}, and i_{2,5,l}, wherein, they correspond to a 4-bit per-polarization amplitude coefficient, a 3-bit per angle-delay domain amplitude coefficient and 16-psk co-phasing coefficients for angle-delay components, respectively. Then, the gNB constructs the precoder for the l-th layer and t=1, 2, . . . , N₃ frequency bin as:

$${W}_{t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] \qquad Equation 5$$

where vₘ_{₁}_{⁽ⁱ⁾}_{,m}_{₂}_{⁽ⁱ⁾} is a 2D-DFT basis vector as defined in Equation 2 and p_{l,x}⁽¹⁾=0,1 is an amplitude coefficient for the x-th cross-polarization. Additionally, y_{t,l}^{(f)} is the t=1, 2, . . . , N₃-th element of f-th FD basis vector as selected by i_{1,5,l} and i_{1,6,l}. Finally, p_{l,i,f}⁽²⁾ and ω_{l,i,f} are the amplitude and phase coefficients for the (i-th, f-th) angle-delay pair.

In one method, Method II.3.1, of the disclosure, a UE derives N co-phasing factors that may be applied in the future N application time intervals when a UE reports for time-correlated CSI. The time intervals may be defined with a granularity of slots, subframes, symbols or other units of time. In particular, when a UE is configured with higher layer parameter codebookType set to ‘typeII-r16’ or ‘typeII-PortSelection-r16’ and the parameter timeCorrelatedCSI in the CSI report configuration is enabled, each PMI value corresponds to a codebook indicator i₁ and subindicators of i_{2,3,l}, i_{2,4,l} and N co-phasing coefficients {i_{2,5,n,l}}ₙ₌₁^{N} that may be applied for application time index n=1, 2, . . . , N. Moreover, i_{2,5,n,l} along the reported i₁, and the other components of i₂ may be used by gNB to construct the precoder in the application time nϵ{1, 2, . . . , N}. In this example of the disclosure, therefore, the spatial information of the reported CSI is kept the same across the time intervals n=1, 2, . . . , N while only the co-phasing information is changing and reported by the values {i_{2,s,n,l}}ₙ₌₁^{N}.

In a yet another embodiment of the disclosure, Method II.3.2, a UE derives N−1 additional Doppler co-phasing correction coefficients that may be applied in the future additional N−1 application time intervals in addition to a reference application time interval which does not require correction. The time intervals may be defined with the granularity of slots, subframes, symbols or other units of time. In particular, when a UE is configured with higher layer parameter codebookType set to ‘typeII-r16” and the parameter timeCorrelatedCSI in the CSI report configuration is enabled, each PMI value corresponds to a codebook indicator i₁ and i₂ are reported to the reference application time n=0 while a layer specific additional Doppler co-phasing correction coefficients indicators i_{3,l} where each indicator consists of N−1 sub-indicators, i.e., i_{3,l}={i_{3,1,l}, i_{3,2,l}, . . . , i_{3,N-1,l}}. In particular, the sub-indicator i_{3,n,l} along the reported i₁ and i₂, is used by gNB to construct the precoder in the application time nϵ{1, . . . , N−1}. Moreover, the Doppler co-phasing correction information indicated via a sub-indicator i_{3,n,l} may be mapped to a value [c_{l,0,n}⁽³⁾, . . . , c_{l,M}_{ᵥ}_{-1,n}⁽³⁾] where c_{l,f,n}⁽³⁾=[c_{l,0,f,n}⁽³⁾, . . . , c_{l,2L-1,f,n}⁽³⁾]. The coefficient c_{l,i,f,n}⁽³⁾ϵ{0, 1, . . . , N_{PSK}^{Doppler}−1} which is in turn mapped to a co-phasing coefficient

$${ϕ}_{l , i , f , n} = e {\frac{j π {c}_{l , i , f , n}^{( 3 )}}{{N}_{P S K}^{D o p p l e r}}}^{{n}^{′} / 16} .$$

In one exemplar embodiment, the value of N_{PSK}^{Doppler} may be set as one of N_{PSK}^{Doppler}ϵ{2,4,8,16}. The spatial, co-phasing and Doppler co-phasing correction information may then be used to construct the precoder associated to a particular layer at application time n denoted as Wₜ^{l}(n) is given as:

$${W}_{t}^{l} ( n ) = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} {ϕ}_{l , i , f , n} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f} {ϕ}_{l , i , f , n}\end{matrix} ] \qquad Equation 6$$

As another variant of Method II.3.2, a method, Method II.3.2-1, may be considered wherein the indicator i_{3,l}={i_{3,1,l}, i_{3,2,l}, . . . , i_{3,N-1,l}} for Doppler co-phasing correction coefficients may be reported in delay (FD-basis)-common manner. Then, the sub-indicator i_{3,n,l} for application time n may be mapped to a value c_{l,n}⁽³⁾=[c_{l,0,n}⁽³⁾, . . . , c_{l,2L-1,n}⁽³⁾]. The coefficient c_{l,i,n}⁽³⁾ϵ{0,1, . . . , N_{PSK}^{Doppler}−1} which is in turn mapped to a co-phasing coefficient

$${ϕ}_{l , i , n} = e {\frac{j π {c}_{l , i , n}^{( 3 )}}{{N}_{P S K}^{D o p p l e r}}}^{{n}^{′} / 16} .$$

In an embodiment, the value of N_{PSK}^{Doppler} may be set as one of N_{PSK}^{Doppler}ϵ{2,4,8,16}. The spatial, co-phasing and Doppler co-phasing correction information may then be used to construct the precoder associated to a particular layer at application time n denoted as Wₜ^{l}(n) is given as:

$${W}_{t}^{l} ( n ) = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {ϕ}_{l , i , n} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] \qquad Equation 7$$

The above equation is given as a specific example on how the disclosure may be applied to the case wherein a UE is configured with a codebook configuration set as ‘typeII-r16’. However, without loss of generality, when the UE is configured to a codebook type ‘typeII-PortSelection-r16’, the disclosure including Method II.2.1 and Method II.2.2 may be applied in a straightforward manner. For example, in the case wherein a UE is configured to codebook type set to ‘typeII-PortSelection-r16’, Equation 4 is modified by replacing the spatial basis vectors {vₘ_{₁}_{⁽ⁱ⁾}_{,m}_{₂}_{⁽ⁱ⁾}} with the appropriate vectors that corresponds to the selected CSI-RS ports.

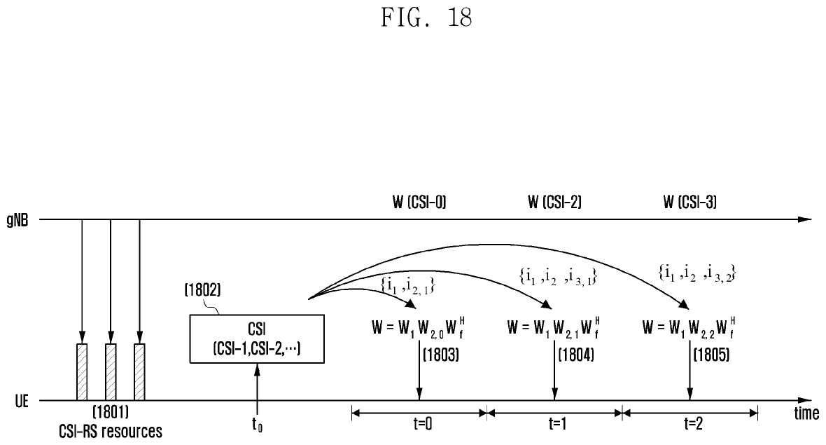

FIG. 18 provides an illustration of Method II.3.2 with N=2 according to an embodiment of the disclosure.

Referring to FIG. 18, a UE may derive a CSI which contains a reference CSI, CSI-0, and N=2 additional CSI with Doppler co-phasing correction coefficients {i_{1,3,t}}ₜ₌₁². The gNB derives the precoders W=W₁W_{2,n}W_{f}^{H} for the reference application time n=0 (1803) as the legacy eType II CSI, i.e., based on the indicators {i₁, i₂}. Additionally, the Doppler co-phasing correction information indicated via {i_{1,3,n}}ₙ₌₁² can be used by gNB to derive precoders (1804) and (1805) for application time n=1, 2. Thus, additional Doppler co-phasing correction coefficients ϕ are used to capture the progression of W_{2,n} in time intervals. Reference marks 1801 and 1802 are similar to 1501 and 1502 and as such the definition thereof is omitted

To further reduce the CSI overhead associated with reporting the Doppler correction coefficients, the number of reported coefficients of i_{3,l} may be further reduced. In one sub-Method II.3, a UE may correct/update the co-phasing correction coefficients for only a subset of angle-delay pairs. In an embodiment, an RRC based configuration for the number of angle-delay pairs may be provided to the UE. A parameter K^{Doppler}, e.g., named K-DopplerUpdatedCoeffcients, may be configured to the UE with RRC parameter. Upon receiving of such configuration, a UE may report Doppler co-phasing coefficients only for the weakest K^{Doppler} angle-delay pairs. Based on a different configuration, a UE, up on receiving of such configuration, may report Doppler co-phasing coefficients only for the strongest K^{Doppler} angle-delay pairs.

In a yet another embodiment, a gNB may update the value of K^{Doppler} via dynamic signaling such as MAC-CE or DCI based (re)configuration. This may be important in the case that the channel condition, the relative speed of the UE with respect of the gNB and other factors change dynamically.

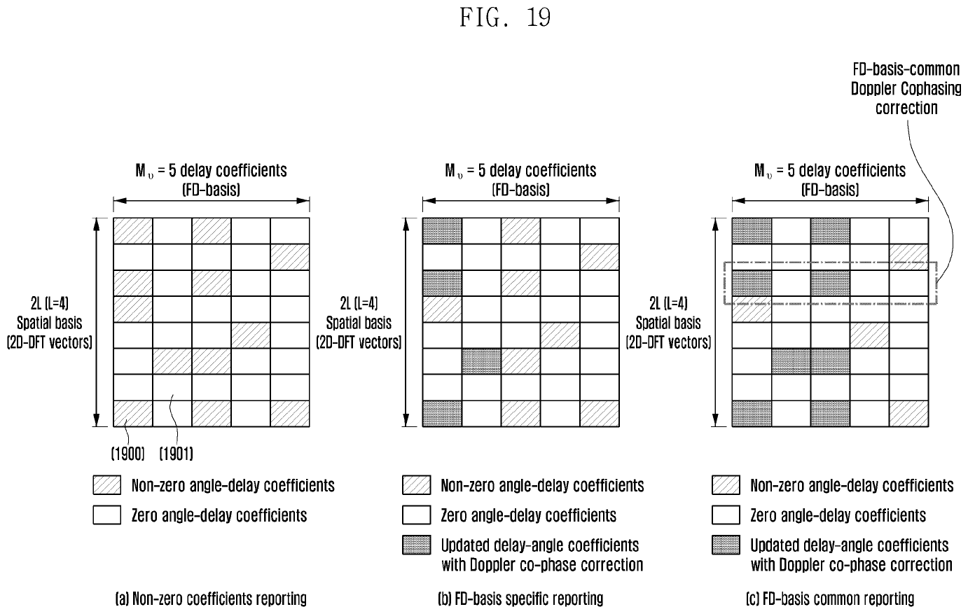

FIG. 19 provides an illustration of an embodiment of Method II.3 according to an embodiment of the disclosure.

Referring to FIG. 19, a UE is configured to report up to 2K₀ nonzero coefficients. If the UE reports, K^{NZ}«2K₀ nonzero coefficients (1900) among 2L×Mᵥ coefficients, the amplitude and co-phasing coefficients for the zero coefficients (1901) will not be reported.

Furthermore, the UE may update Co-phasing correction coefficients for a subset of non-zero elements as shown in parts (b) and (c) of FIG. 19. If a parameter K^{Doppler}, i.e., the number of updates is configured to the UE and the Doppler co-phasing correction is to be updated in a delay-angle (FD specific manner (at part (b) of FIG. 19), then the UE reports K^{Doppler} Doppler co-phasing correction coefficients to the selected angle-delay pairs (considering the weakest or strongest coefficients). On the other hand, if the UE is configured with a parameter K^{Doppler}, i.e., the number of updates is configured to the UE and the Doppler co-phasing correction is to be updated in a FD-basis-common manner part (c) of FIG. 19, then the UE reports K^{Doppler} Doppler co-phasing correction coefficients to the selected angle (based on UE-gNB agreement on reporting the weakest or strongest coefficients). In another words, if the Doppler co-phasing correction coefficients are configured to be reported in FD-basis-common manner, then the UE reports K^{Doppler} Doppler co-phasing correction coefficients and each reported coefficient is applied to all nonzero coefficients in the corresponding spatial basis (i.e., 2D-DFT beam or CSI-RS port index). To configure the UE with either FD-basis specific or FD-basis common Doppler co-phasing correction update, this disclosure introduces an RRC parameter, e.g., named as FD-commonDopplerUpdate. If FD-commonDopplerUpdate is enabled the co-phasing correction coefficients are updated in FD-basis common manner; otherwise, they are updated in FD-basis specific manner.

CodebookConfig-r16 ::= SEQUENCE {
codebookType CHOICE {
type2 SEQUENCE, {
subType CHOICE {
typeII-r16 SEQUENCE {
n1-n2-codebookSubsetRestriction-r16 CHOICE {
.
.
.
},
typeII-RI-Restriction-r16 BIT STRING (SIZE(4))
},
typeII-PortSelection-r16 SEQUENCE {
portSelectionSamplingSize-r16 ENUMERATED {n1, n2, n3, n4},
typeII-PortSelectionRI-Restriction-r16 BIT STRING (SIZE (4))
}
},
numberOfPMI-SubbandsPerCQI-Subband-r16 INTEGER (1..2),
paramCombination-r16 INTEGER (1..8)
}
}
}
K-DopplerUpdatedCoeffcientsENUMERATED {two, three, four, six}
OPTIONAL
FD-commonDopplerUpdate ENUMERATED {enabled} OPTIONAL

Part II.4: Report Based on Further Enhanced Type II CSI

In this subsection, the description of the disclosure is provided by exemplifying it with respect to Further Enhanced Type II Port Selection Codebook in the 5G NR system. In the further enhanced Type II port selection codebook (FeType II PS CB), a UE reports indicators i₁ and i₂. The indicator i₁ which may include sub-indicators i_{1,2}, i_{1,6,l}, i_{1,7,l}, i_{1,8,l}, for transmission layers lϵ{1,2,3,4}, indicates the spatial channel information and the frequency domain (FD) basis information. In particular, the indicators i_{1,2} selects and indicates CSI-RS ports whereas i_{1,6,l} select M FD DFT basis. Furthermore, the subindicator i_{1,7,l} indicates the position of nonzero coefficients from 2L×M elements of W₂ (706) and i_{1,8,l} indicates the strongest coefficient of layer l. Moreover, the indicator i₂ consisting subindicators i_{2,3,l}, i_{2,4,l}, and i_{2,5,l}, wherein, they correspond to a 4-bit per-polarization amplitude coefficient, a 3-bit per angle-delay domain amplitude coefficient and 16-psk co-phasing coefficients for angle-delay components, respectively. Then, the gNB constructs the precoder for the l-th layer and t=1, 2, . . . , N₃ frequency bin as:

$${W}_{t}^{l} ( n ) = \frac{1}{\sqrt{{γ}_{t , l}}} [ \begin{matrix}{\sum }_{i = 0}^{L - 1} {v}_{{m}^{( i )}} {p}_{l , 0}^{( 1 )} {\sum }_{f = 0}^{M - 1} {y}_{t}^{( f )} {p}_{l , i , f}^{( 2 )} {φ}_{l , i , f} \\ {\sum }_{i = 0}^{L - 1} {v}_{{m}^{( i )}} {p}_{l , 1}^{( 1 )} {\sum }_{f = 0}^{{M}_{υ} - 1} {y}_{t}^{( f )} {p}_{l , i + L , f}^{( 2 )} {φ}_{l , i + L , f}\end{matrix} ] \qquad Equation 8$$

where vₘ(i) is a basis vector associated with the i-th CSI-RS port and p_{l,x}⁽¹⁾, x=0, 1 is an amplitude coefficient for the x-th cross-polarization. Additionally, yₜ^{(f)} is the t=1, 2, . . . , N₃-th element off-th FD basis vector as selected by i_{1,6,l}. Finally, p_{l,i,f}⁽²⁾ and φ_{l,i,f} are the amplitude and phase coefficients for the (i-th, f-th) angle-delay pair.

In one Method II.4.1 of the disclosure, a UE derives N Doppler co-phasing correction coefficients that may be applied in the future N application time intervals when a UE reports for time-correlated CSI. The time intervals may be defined with a granularity of slots, subframes, symbols or other units of time. In particular, when a UE is configured with higher layer parameter codebookType set to ‘typeII-r16’ and the parameter timeCorrelatedCSI in the CSI report configuration is enabled, each PMI value corresponds to a codebook indicator i₁ and subindicators of i_{2,3,l}, i_{2,4,l} and N co-phasing coefficients {i_{2,5,n,l}}ₙ₌₁^{N} that may be applied for application time index n=1, 2, . . . , N. Moreover, i_{2,5,n,l} along the reported i₁, and the other components of i₂ is used by gNB to construct the precoder in the application time nϵ{1, 2, . . . , N}. In this example of the disclosure, therefore, the spatial information of the reported CSI is kept the same across the time intervals n=1, 2, . . . , N while only the co-phasing information is changing and reported by the values {i_{2,5,n,l}}ₙ₌₁^{N}.

In a yet another part of the disclosure, Method II.4.2, a UE derives N−1 additional Doppler co-phasing correction coefficients that may be applied in the future additional N−1 application time intervals in addition to a reference application time interval which does not require correction. The time intervals may be defined with the granularity of slots, subframes, symbols or other units of time. In particular, when a UE is configured with higher layer parameter codebookType set to ‘typeII-PortSelection-r17” and the parameter timeCorrelatedCSI in the CSI report configuration is enabled, each PMI value corresponds to a codebook indicator i₁ and i₂ are reported to the reference application time n=0 while a layer specific additional Doppler co-phasing correction coefficients indicators i_{3,l} where each indicator consists of N−1 sub-indicators, i.e., i_{3,l}={i_{3,1,l}, i_{3,2,l}, . . . , i_{3,N-1,l}}. In particular, the sub-indicator i_{3,n,l} along the reported i₁ and i₂, is used by gNB to construct the precoder in the application time nϵ{2, 3, . . . , N}. Moreover, the Doppler co-phasing correction information indicated via a sub-indicator i_{3,n,l} may be mapped to a value [c_{l,0,n}⁽³⁾, . . . , c_{l,M-1,n}⁽³⁾] where c_{l,f,n}⁽³⁾=[c_{l,0,f,n}⁽³⁾, . . . , c_{l,2L-1,f,n}⁽³⁾]. The coefficient c_{l,i,f,n}⁽³⁾ϵ{0, 1, . . . , N_{PSK}^{Doppler}−1} which is in turn mapped to a co-phasing coefficient

$${ϕ}_{l , i , f , n} = e {\frac{j π {c}_{l , i , f , n}^{( 3 )}}{{N}_{P S K}^{D o p p l e r}}}^{{n}^{′} / 16} .$$

In an embodiment, the value of N_{PSK}^{Doppler} may be set as one of N_{PSK}^{Doppler}ϵ{2,4,8,16}. The spatial, co-phasing and Doppler co-phasing correction information may then be used to construct the precoder associate to a particular layer at application time n denoted as Wₜ^{l}(n) is given as:

$${W}_{t}^{l} ( n ) = \frac{1}{\sqrt{{γ}_{t , l}}} [ \begin{matrix}{\sum }_{i = 0}^{L - 1} {v}_{{m}^{( i )}} {p}_{l , 0}^{( 1 )} {\sum }_{f = 0}^{M - 1} {y}_{t}^{( f )} {p}_{l , i , f}^{( 2 )} {φ}_{l , i , f} {ϕ}_{l , i , f , n} \\ {\sum }_{i = 0}^{L - 1} {v}_{{m}^{( i )}} {p}_{l , 1}^{( 1 )} {\sum }_{f = 0}^{M - 1} {y}_{t}^{( f )} {p}_{l , i + L , f}^{( 2 )} {φ}_{l , i + L , f} {ϕ}_{l , i , f , n}\end{matrix} ] \qquad Equation 9$$

As another variant of Method II.4.2, a method, Method II.4.2-2 may be considered wherein the indicator i_{3,l}={i_{3,1,l}, i_{3,2,l}, . . . , i_{3,N-1,l}} for Doppler co-phasing correction coefficients may be reported in delay (FD-basis)-common manner. Then, the sub-indicator i_{3,n,l} for application time n may be mapped to a value c_{l,n}⁽³⁾=[c_{l,0,n}⁽³⁾, . . . , c_{l,2L-1,n}⁽³⁾]. The coefficient c_{l,i,n}⁽³⁾ϵ{0, 1, . . . , N_{PSK}^{Doppler}−1} which is in turn mapped to a co-phasing coefficient

$${ϕ}_{l , i , n} = e {\frac{j π {c}_{l , i , n}^{( 3 )}}{{N}_{P S K}^{D o p p l e r}}}^{{n}^{′} / 16} .$$

In one exemplar embodiment, the value of N_{PSK}^{Doppler} may be set as one of N_{PSK}^{Doppler}ϵ{2,4,8,16}. The spatial, co-phasing and Doppler co-phasing correction information may then be used to construct the precoder associated to a particular layer at application time n denoted as Wₜ^{l}(n) is given as:

$${W}_{t}^{l} ( n ) = \frac{1}{\sqrt{{γ}_{t , l}}} [ \begin{matrix}{{\sum }^{L - 1}}_{i = 0} {v}_{{m}^{( i )}} {p}_{l , 0}^{( 1 )} {ϕ}_{l , i , n} {{\sum }_{f = 0}}^{M - 1} {y}_{t}^{( f )} {p}_{l , i , f}^{( 2 )} {φ}_{l , i , f} \\ {{\sum }^{L - 1}}_{i = 0} {v}_{{m}^{( i )}} {p}_{l , 1}^{( 1 )} {{\sum }_{f = 0}}^{{M}_{υ} - 1} {y}_{t}^{( f )} {p}_{l , i + L , f}^{( 2 )} {φ}_{l , i + L , f}\end{matrix} ] \qquad Equation 10$$

To further reduce the CSI overhead associated with reporting the Doppler correction coefficients, the number of reported coefficients of i_{3,l} may be further reduced. In one sub-Method II.3, a UE may correct/update the co-phasing correction coefficients for only a subset of angle-delay pairs. In an embodiment, an RRC based configuration for the number of angle-delay pairs may be provided to the UE. A parameter K^{Doppler} may be configured to the UE with RRC parameter. Upon receiving of such configuration, a UE may report Doppler co-phasing coefficients only for the weakest K^{Doppler} angle-delay pairs. Based on a different configuration, a UE, up on receiving of such configuration, may report Doppler co-phasing coefficients only for the strongest K^{Doppler} angle-delay pairs.

In a yet another embodiment, a gNB may update the value of K^{Doppler} via dynamic signaling such as MAC-CE or DCI based (re)configuration. This may be important in the case that the channel condition, the relative speed of the UE with respect to the gNB and other factors change dynamically.

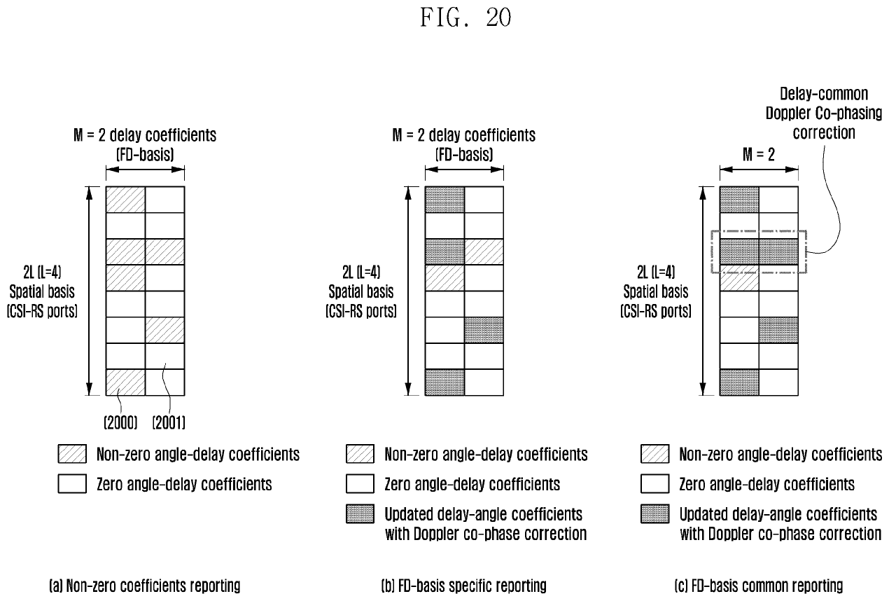

FIG. 20 provides an illustration of an embodiment of Method II.4 according to an embodiment of the disclosure.

Referring to FIG. 20, a UE is configured to report up to 2K₀ nonzero coefficients. If the UE reports, K^{NZ}«2K₀ nonzero coefficients (2000) among the 2L×Mᵥ angle-delay pairs, the amplitude and co-phasing coefficients for the zero coefficients (2001) 2L×Mᵥ−K^{NZ} will not be reported. Furthermore, the UE may update Co-phasing correction coefficients for a subset of non-zero elements as shown in parts (b) and (c) of FIG. 20. If a parameter K^{Doppler} i.e., the number of updates is configured to the UE and the Doppler co-phasing correction is to be updated in a delay-angle (FD specific manner (part (b) of FIG. 20), then the UE reports K^{Doppler} Doppler co-phasing correction coefficients to the selected angle-delay pairs (considering the weakest or strongest coefficients). On the other hand, if the UE is configured with a parameter K^{Doppler} i.e., the number of updates is configured to the UE and the Doppler co-phasing correction is to be updated in a FD-basis-common manner (part (c) of FIG. 20), then the UE reports K^{Doppler} Doppler co-phasing correction coefficients to the selected spatial basis (angles) (based on UE-gNB agreement on reporting the weakest or strongest coefficients). In another words, if the Doppler co-phasing correction coefficients are configured to be reported in FD-basis-common manner, then the UE reports K^{Doppler} Doppler co-phasing correction coefficients and each reported coefficient is applied to all nonzero coefficients in the corresponding spatial basis (i.e., 2D-DFT beam or CSI-RS port index).

In accordance with another aspect of the disclosure, a method performed by a base station in a wireless communication system is provided, the method includes transmitting, to a terminal, configuration information about CSI-RS resources for time-correlated CSI measurement.

In accordance with an aspect of the disclosure, a method performed by a user terminal in a wireless communication system is provided. The method includes receiving, from a base station, configuration information CSI-RS resources for time-correlated CSI measurement.

In accordance with another aspect of the disclosure, a method performed by a base station in a wireless communication system is provided, the method includes transmitting, to a terminal, configuration information about CSI reporting mechanism for time-correlated CSI. In addition, a configuration information based on various codebook types for precoding matrix indicator(s) (PMI(s)) that may be used for time-correlated CSI is disclosed.

In accordance with another aspect of the disclosure, a method performed by a terminal in a wireless communication system is provided, the method includes, from a base station, configuration information for CSI reporting mechanism for time-correlated CSI measurement. In addition, according to the codebook configuration information, a terminal derives a PMI(s) for time-correlated CSI.

In accordance with another aspect of the disclosure, a method performed by a terminal in a wireless communication system is provided, the method includes indications of terminal's capability on measuring and reporting time-correlated CSI.

In accordance with another aspect of the disclosure, a method performed by a base station in a wireless communication system is provided, the method includes receiving terminal's capability information and providing a corresponding configuration information time-correlated CSI measurement and reporting.

While the disclosure has been shown and described with reference to various embodiments thereof, it will be understood by those skilled in the art that various changes in form and details may be made therein without departing from the spirit and scope of the disclosure as defined by the appended claims and their equivalents.

### ABBREVIATIONS

2D Two-dimensional
ACK Acknowledgement
AoA Angle of arrival
AoD Angle of departure
ARQ Automatic Repeat Request
BW Bandwidth
CDM Code Division Multiplexing
CP Cyclic Prefix
C-RNTI Cell RNTI
CRS Common Reference Signal
CRI CSI-RS resource indicator
CSI Channel State Information
CSI-RS Channel State Information Reference Signal
CQI Channel Quality Indicator
DCI Downlink Control Information
dB deciBell
DL Downlink
DL-SCH DL Shared Channel
DMRS Demodulation Reference Signal
eMBB Enhanced mobile broadband
eNB eNodeB (base station)
FDD Frequency Division Duplexing
FDM Frequency Division Multiplexing
FFT Fast Fourier Transform
HARQ Hybrid ARQ
IFFT Inverse Fast Fourier Transform
LAA License assisted access
LBT Listen before talk
LTE Long-term Evolution
MIMO Multi-input multi-output
mMTC massive Machine Type Communications
MTC Machine Type Communications
MU-MIMO Multi-user MIMO
NACK Negative ACKnowledgement
NW Network
OFDM Orthogonal Frequency Division Multiplexing
PBCH Physical Broadcast Channel
PDCCH Physical Downlink Control Channel
PDSCH Physical Downlink Shared Channel
PHY Physical layer
PRB Physical Resource Block
PMI Precoding Matrix Indicator
PSS Primary Synchronization Signal
PUCCH Physical Uplink Control Channel
PUSCH Physical Uplink Shared Channel
QoS Quality of service
RAN Radio access network
RAT Radio access technology
RB Resource Block
RE Resource Element
RI Rank Indicator
RRC Radio Resource Control
RS Reference Signals
RSRP Reference Signal Received Power
SDM Space Division Multiplexing
SINR Signal to Interference and Noise Ratio
SPS Semi-Persistent Scheduling
SRS Sounding RS
SF Subframe
SSS Secondary Synchronization Signal
SU-MIMO Single-user MIMO
TDD Time Division Duplexing
TDM Time Division Multiplexing
TB Transport Block
TP Transmission point
TRP Transmission reception point
TTI Transmission time interval
UCI Uplink Control Information
UE User Equipment
UL Uplink
UL-SCH UL Shared Channel
URLLC Ultra-reliable low-latency communication

What is claimed is:

1. A method performed by a user equipment (UE) in a communication system, the method comprising:
transmitting, to a base station, capability information indicating a capability for time correlated channel state information (CSI) report;
receiving, from the base station, configuration for the time correlated CSI report;
obtaining N CSI reports based on one or more CSI-reference signals (CSI-RS), the N CSI reports being applied to N time intervals; and
transmitting the N CSI reports to the base station.

2. The method of claim 1, wherein the one or more CSI-RS used for obtaining N CSI reports are determined as all CSI-RS resources in an associated CSI-RS resource set, or sub-selected CSI-RS resources from the associated CSI-RS resource set.

3. The method of claim 2, wherein the CSI-RS resources are sub-selected from the associated CSI-RS resource set based on a higher layer signaling, downlink control information (DCI), or medium access control-control element (MAC-CE).

4. The method of claim 1, wherein the N CSI reports comprises N co-phasing coefficients applied to N time intervals, or N−1 Doppler co-phasing correction coefficients.

5. A method performed by a base station in a communication system, the method comprising:
receiving, from a user equipment (UE), capability information indicating a capability for time correlated channel state information (CSI) report;
transmitting, to the UE, configuration for the time correlated CSI report; and
receiving, from the UE, N CSI reports based on one or more CSI-reference signals (CSI-RS), the N CSI reports being applied to N time intervals.

6. The method of claim 5, wherein the one or more CSI-RS used for obtaining N CSI reports are determined as all CSI-RS resources in an associated CSI-RS resource set, or sub-selected CSI-RS resources from the associated CSI-RS resource set.

7. The method of claim 6, wherein the CSI-RS resources are sub-selected from the associated CSI-RS resource set based on a higher layer signaling, downlink control information (DCI), or medium access control-control element (MAC-CE).

8. The method of claim 5, wherein the N CSI reports comprises N co-phasing coefficients applied to N time intervals, or N−1 Doppler co-phasing correction coefficients.

9. A user equipment (UE) in a communication system, the UE comprising:
a transceiver; and
at least one processor configured to:
transmit, to a base station, capability information indicating a capability for time correlated channel state information (CSI) report,
receive, from the base station, configuration for the time correlated CSI report,
obtain N CSI reports based on one or more CSI-reference signals (CSI-RS), the N CSI reports being applied to N time intervals, and
transmit the N CSI reports to the base station.

10. The UE of claim 9, wherein the one or more CSI-RS used for obtaining N CSI reports are determined as all CSI-RS resources in an associated CSI-RS resource set, or sub-selected CSI-RS resources from the associated CSI-RS resource set.

11. The UE of claim 10, wherein the CSI-RS resources are sub-selected from the associated CSI-RS resource set based on a higher layer signaling, downlink control information (DCI), or medium access control-control element (MAC-CE).

12. The UE of claim 9, wherein the N CSI reports comprises N co-phasing coefficients applied to N time intervals, or N−1 Doppler co-phasing correction coefficients.

13. A base station in a communication system, the baes station comprising:
a transceiver; and
at least one processor configured to:
receive, from a user equipment (UE), capability information indicating a capability for time correlated channel state information (CSI) report,
transmit, to the UE, configuration for the time correlated CSI report, and
receive, from the UE, N CSI reports based on one or more CSI-reference signals (CSI-RS), the N CSI reports being applied to N time intervals.

14. The base station of claim 13,
wherein the one or more CSI-RS used for obtaining N CSI reports are determined as all CSI-RS resources in an associated CSI-RS resource set, or sub-selected CSI-RS resources from the associated CSI-RS resource set, and
wherein the CSI-RS resources are sub-selected from the associated CSI-RS resource set based on a higher layer signaling, downlink control information (DCI), or medium access control-control element (MAC-CE).

15. The base station of claim 13, wherein the N CSI reports comprises N co-phasing coefficients applied to N time intervals, or N−1 Doppler co-phasing correction coefficients.
